(19) United States
(12) Patent Application Publication
(10) Pub. No.: US 2026/0230889 A1
(43) Pub. Date: Aug. 6, 2026

(54) SLOT OFFSETS FOR CROSS-LINK INTERFERENCE MEASUREMENT REPORTING

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Jae Ho RYU, San Diego, CA (US)

(21) Appl. No.: 19/245,567

(22) Filed: Jun. 23, 2025

Related U.S. Application Data
(60) Provisional application No. 63/753,684, filed on Feb. 4, 2025.

(51) Int. Cl. H04W 24/10; H04B 17/318; H04L 5/14; H04W 72/23

(52) U.S. Cl. CPC H04W 24/10; H04B 17/328; H04L 5/14; H04W 72/23

(57) ABSTRACT

Various aspects of the present disclosure generally relate to wireless communication. In some aspects, a user equipment (UE) may receive downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources. The UE may transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing. Numerous other aspects are described.

### CROSS-REFERENCE TO RELATED APPLICATION

This Patent Application claims priority to U.S. Provisional Patent Application No. 63/753,684, filed on Feb. 4, 2025, entitled “SLOT OFFSETS FOR CROSS-LINK INTERFERENCE MEASUREMENT REPORTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with slot offsets for cross-link interference measurement reporting.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at a user equipment (UE) includes one or more memories; and one or more processors, coupled to the one or more memories, configured to cause the UE to: receive downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources; and transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, an apparatus for wireless communication at a UE includes one or more memories; and one or more processors, coupled to the one or more memories, configured to cause the UE to: receive signaling that triggers a set of CLI resources, wherein the set of CLI resources includes CLI SRS-RSRP resources or CLI-RSSI resources; and transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, an apparatus for wireless communication at a network node includes one or more memories; and one or more processors, coupled to the one or more memories, configured to cause the network node to: transmit DCI that triggers a set of aperiodic CLI resources, wherein the set of aperiodic CLI resources includes a set of aperiodic CLI SRS-RSRP resources or a set of aperiodic CLI-RSSI resources; and receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, an apparatus for wireless communication at a network node includes one or more memories; and one or more processors, coupled to the one or more memories, configured to cause the network node to: transmit signaling that triggers a set of CLI resources, wherein the set of CLI resources includes CLI SRS-RSRP resources or CLI-RSSI resources; and receive a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, a method of wireless communication performed by a UE includes receiving DCI that triggers a set of aperiodic CLI resources, wherein the set of aperiodic CLI resources includes a set of aperiodic CLI SRS-RSRP resources or a set of aperiodic CLI-RSSI resources; and transmitting a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, a method of wireless communication performed by a UE includes receiving signaling that triggers a set of CLI resources, wherein the set of CLI resources includes CLI SRS-RSRP resources or CLI-RSSI resources; and transmitting a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, a method of wireless communication performed by a network node includes transmitting DCI that triggers a set of aperiodic CLI resources, wherein the set of aperiodic CLI resources includes a set of aperiodic CLI SRS-RSRP resources or a set of aperiodic CLI-RSSI resources; and receiving a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, a method of wireless communication performed by a network node includes transmitting signaling that triggers a set of CLI resources, wherein the set of CLI resources includes CLI SRS-RSRP resources or CLI-RSSI resources; and receiving a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, a non-transitory computer-readable medium storing a set of instructions for wireless communication includes one or more instructions that, when executed by one or more processors of a UE, cause the UE to: receive DCI that triggers a set of aperiodic CLI resources, wherein the set of aperiodic CLI resources includes a set of aperiodic CLI SRS-RSRP resources or a set of aperiodic CLI-RSSI resources; and transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, a non-transitory computer-readable medium storing a set of instructions for wireless communication includes one or more instructions that, when executed by one or more processors of an UE, cause the UE to: receive signaling that triggers a set of CLI resources, wherein the set of CLI resources includes CLI SRS-RSRP resources or CLI-RSSI resources; and transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, a non-transitory computer-readable medium storing a set of instructions for wireless communication includes one or more instructions that, when executed by one or more processors of a network node, cause the network node to: transmit DCI that triggers a set of aperiodic CLI resources, wherein the set of aperiodic CLI resources includes a set of aperiodic CLI SRS-RSRP resources or a set of aperiodic CLI-RSSI resources; and receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, a non-transitory computer-readable medium storing a set of instructions for wireless communication includes one or more instructions that, when executed by one or more processors of a network node, cause the network node to: transmit signaling that triggers a set of CLI resources, wherein the set of CLI resources includes CLI SRS-RSRP resources or CLI-RSSI resources; and receive a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, an apparatus for wireless communication includes means for receiving DCI that triggers a set of aperiodic CLI resources, wherein the set of aperiodic CLI resources includes a set of aperiodic CLI SRS-RSRP resources or a set of aperiodic CLI-RSSI resources; and means for transmitting a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, an apparatus for wireless communication includes means for receiving signaling that triggers a set of CLI resources, wherein the set of CLI resources includes CLI SRS-RSRP resources or CLI-RSSI resources; and means for transmitting a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

In some implementations, an apparatus for wireless communication includes means for transmitting DCI that triggers a set of aperiodic CLI resources, wherein the set of aperiodic CLI resources includes a set of aperiodic CLI SRS-RSRP resources or a set of aperiodic CLI-RSSI resources; and means for receiving a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

In some implementations, an apparatus for wireless communication includes means for transmitting signaling that triggers a set of CLI resources, wherein the set of CLI resources includes CLI SRS-RSRP resources or CLI-RSSI resources; and means for receiving a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating examples of full duplex (FD) communications.

FIG. 4 is a diagram illustrating examples of FD communications.

FIG. 5 is a diagram illustrating an example of cross-link interference (CLI).

FIG. 6 is a diagram illustrating an example of CLI.

FIG. 7 is a diagram illustrating an example of CLI.

FIG. 8 is a diagram illustrating an example of slot offsets for CLI measurement reporting.

FIG. 9 is a diagram illustrating an example of CLI measurements.

FIG. 10 is a diagram illustrating an example of uplink transmissions or downlink receptions across subband full duplex (SBFD) symbols and non-SBFD symbols.

FIGS. 11-12 are flowcharts illustrating example processes performed, for example, by a UE.

FIGS. 13-14 are flowcharts illustrating example processes performed, for example, by a network node.

FIGS. 15-16 are diagrams of example apparatuses for wireless communication.

### DETAILED DESCRIPTION

In a wireless communications network, a full duplex operation may result in cross-link interference (CLI). The CLI may occur when a first signal from a first link interferes with a second signal from a second link. The full duplex operation may involve a subband full duplex (SBFD) operation, in which a transmission and a reception may occur at the same time but on different frequency resources. The CLI may occur when an uplink transmission associated with a first user equipment (UE) or a first network node interferes with a downlink transmission associated with a second UE or a second network node. In this example, the first UE may be an aggressor UE and the second UE may be a victim UE. CLI may occur between network nodes and/or between UEs.

For inter-UE CLI, a layer 1 (L1) based UE-to-UE CLI measurement and reporting may be based at least in part on a channel state information (CSI) framework. The L1 based UE-to-UE CLI measurement and reporting may involve measurement resources. The measurement resources may include periodic, semi-persistent, or aperiodic measurement resources (or resource sets) (e.g., sounding reference signal (SRS) reference signal received power (RSRP) (SRS-RSRP) resources or CLI received signal strength indicator (RSSI) (CLI-RSSI) resources). The L1 based UE-to-UE CLI measurement and reporting may involve measurement reporting, which may include aperiodic, periodic, or semi-persistent reporting. Report quantities may include L1-SRS-RSRP, L1-CLI-RSSI, and/or measurement resource indices.

An L1 CLI measurement and reporting may be based at least in part on a slot offset for an aperiodic CLI RSSI/RSRP resource. For an aperiodic SRS-RSRP reporting using an aperiodic SRS-RSRP measurement resource set, a slot offset between a slot containing a downlink control information (DCI) that triggers a set of aperiodic SRS-RSRP resources and a slot in which an SRS-RSRP resource set is measured may be configured by a higher layer parameter. The slot offset may be configured based at least in part on a legacy SRS resource set and/or an available slot offset list. For an aperiodic CLI-RSSI reporting using an aperiodic CLI-RSSI measurement resource set, a slot offset between a slot containing a DCI that triggers a set of aperiodic CLI-RSSI resources and a slot in which a CLI-RSSI resource set is measured may be configured by a higher layer parameter. At least for an SRS-RSRP measurement in an uplink subband of an SBFD symbol, when the second UE measures an SRS-RSRP and/or a CLI-RSSI, a constant offset relative to a downlink reference timing in a serving cell may be applied. The constant offset value may be derived by a UE implementation.

The first UE, which may be the aggressor UE, may transmit in an uplink subband of an SBFD symbol. The second UE, which may be the victim UE, may measure an SRS-RSRP and/or a CLI-RSSI in the uplink subband of the SBFD symbol. The first UE may transmit in accordance with an uplink timing. The second UE, in order to measure the SRS-RSRP and/or the CLI-RSSI, may use an offset value to match the uplink timing associated with the first UE. The second UE may apply a constant offset relative to a downlink reference timing, which may allow the second UE to measure the SRS-RSRP and/or a CLI-RSSI. The second UE may switch from the downlink reference timing to a CLI measurement timing based at least in part on the constant offset. The CLI measurement timing for the second UE may be associated with the uplink timing of the first UE. However, in some cases, the second UE may have an insufficient amount of time to switch between the downlink reference timing and the CLI measurement timing in order to perform an SRS-RSRP measurement and/or a CLI-RSSI measurement. For example, a slot that contains a DCI that triggers a set of aperiodic SRS-RSRP or CLI-RSSI resources and a slot in which an SRS-RSRP or CLI-RSSI resource set is measured may be the same slot (e.g., the DCI and the SRS-RSRP or CLI-RSSI resource set may be separated by 2 or 3 symbols within the same slot). When the DCI and the SRS-RSRP or CLI-RSSI resource set are associated with the same slot, the second UE may not have sufficient time to switch from the downlink reference timing to the CLI measurement timing, which may prevent the second UE from performing the SRS-RSRP measurement and/or the CLI-RSSI measurement, thereby degrading an overall system performance.

Various aspects relate generally to CLI. Some aspects more specifically relate to slot offsets for CLI measurement reporting. In some examples, a UE may receive, from a network node, DCI that triggers a set of aperiodic CLI resources. The set of aperiodic CLI resources may include a set of aperiodic CLI SRS-RSRP resources or a set of aperiodic CLI-RSSI resources. The UE may transmit, to the network node, a report of one or more measurements associated with the set of aperiodic CLI resources. A slot offset between a slot associated with the DCI that triggers the set of aperiodic CLI resources and a slot in which the set of aperiodic CLI resources are measured may be based at least in part on a minimum timing. The slot offset between the slot associated with the DCI that triggers the set of aperiodic CLI SRS-RSRP resources and the slot in which the set of aperiodic CLI SRS-RSRP resources are measured may be more than zero slots in accordance with the minimum timing (e.g., the slot offset may not be equal to zero slots). The minimum timing may be at least one slot to accommodate a timing switching for CLI measurement that occurs at a slot boundary. A switching time between a downlink reference timing and a CLI measurement timing to measure the set of aperiodic CLI resources may be based at least in part on the minimum timing.

Particular aspects of the subject matter described in this disclosure can be implemented to realize one or more of the following potential advantages. In some examples, by configuring the slot offset between the slot associated with the DCI that triggers the set of aperiodic CLI resources and the slot in which the set of aperiodic CLI resources are measured to be in accordance with the minimum timing, the described techniques can be used by the UE to have sufficient time to perform and report the one or more measurements associated with the set of aperiodic CLI resources. The one or more measurements may include CLI SRS-RSRP measurements and/or CLI-RSSI measurements. The slot associated with the DCI that triggers the set of aperiodic CLI resources and the slot in which the set of aperiodic CLI resources are measured may be different slots, which may allow the UE to accurately perform and report the one or more measurements. The network node may be able to use the one or more measurements to perform a CLI mitigation, thereby improving an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

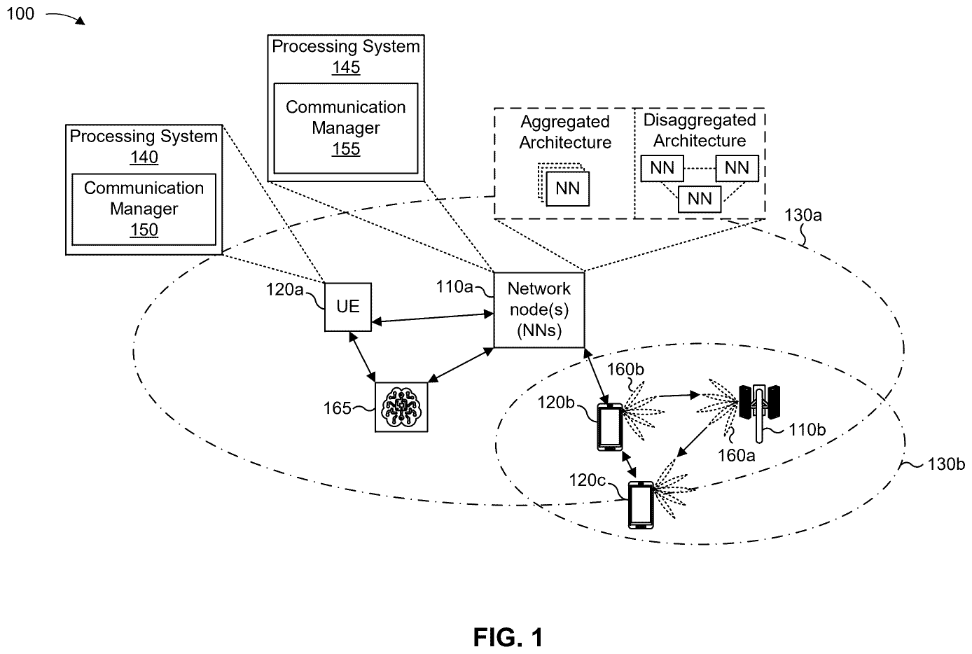

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a CSI reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, an L1-RSRP parameter, an RSSI parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a UE (e.g., the UE 120) may include a communication manager 150. As described in more detail elsewhere herein, the communication manager 150 may receive DCI that triggers a set of aperiodic CLI resources, wherein the set of aperiodic CLI resources includes a set of aperiodic CLI SRS-RSRP resources or a set of aperiodic CLI-RSSI resources; and transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing. As described in more detail elsewhere herein, the communication manager 150 may receive signaling that triggers a set of CLI resources, wherein the set of CLI resources includes CLI SRS-RSRP resources or CLI-RSSI resources; and transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit DCI that triggers a set of aperiodic CLI resources, wherein the set of aperiodic CLI resources includes a set of aperiodic CLI SRS-RSRP resources or a set of aperiodic CLI-RSSI resources; and receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing. As described in more detail elsewhere herein, the communication manager 155 may transmit signaling that triggers a set of CLI resources, wherein the set of CLI resources includes CLI SRS-RSRP resources or CLI-RSSI resources; and receive a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols. Additionally, or alternatively, the communication manager 155 may perform one or more other operations described herein.

As indicated above, FIG. 1 is provided as an example. Other examples may differ from what is described with regard to FIG. 1.

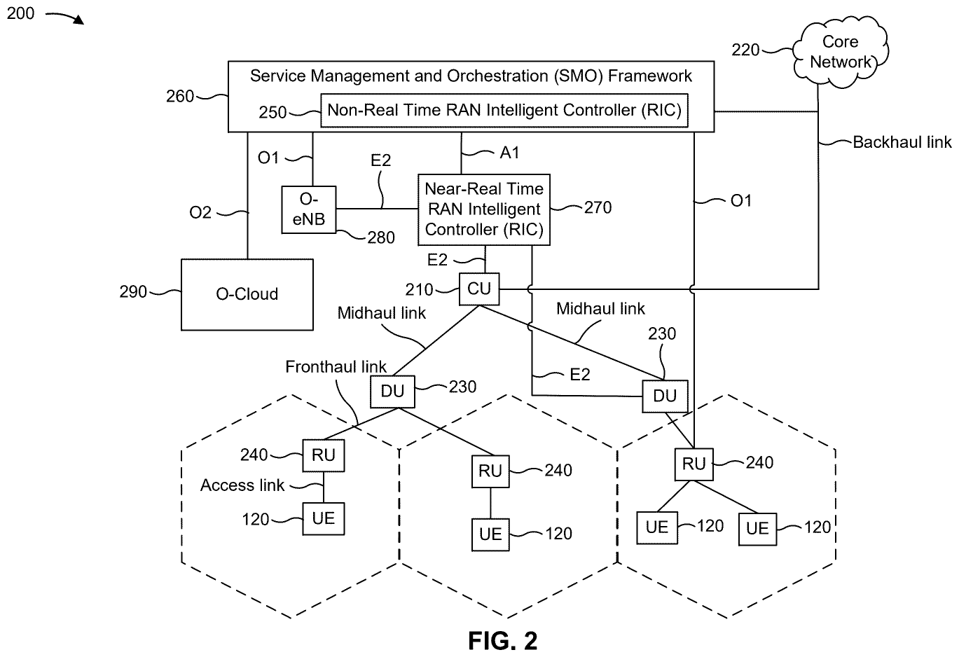

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

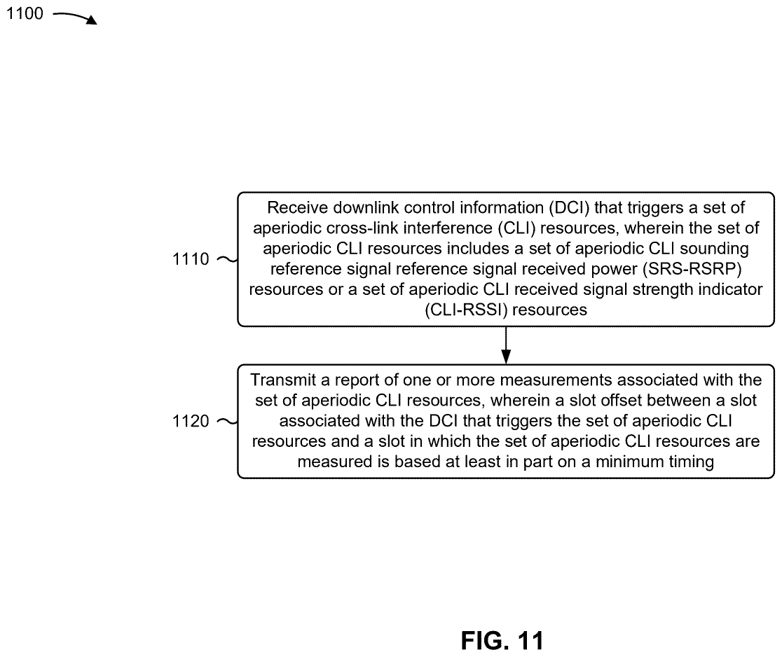

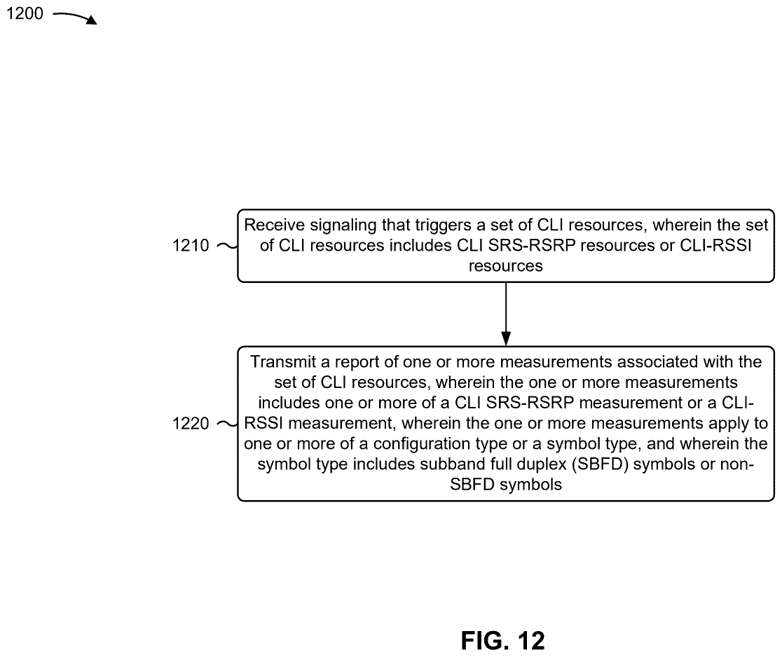

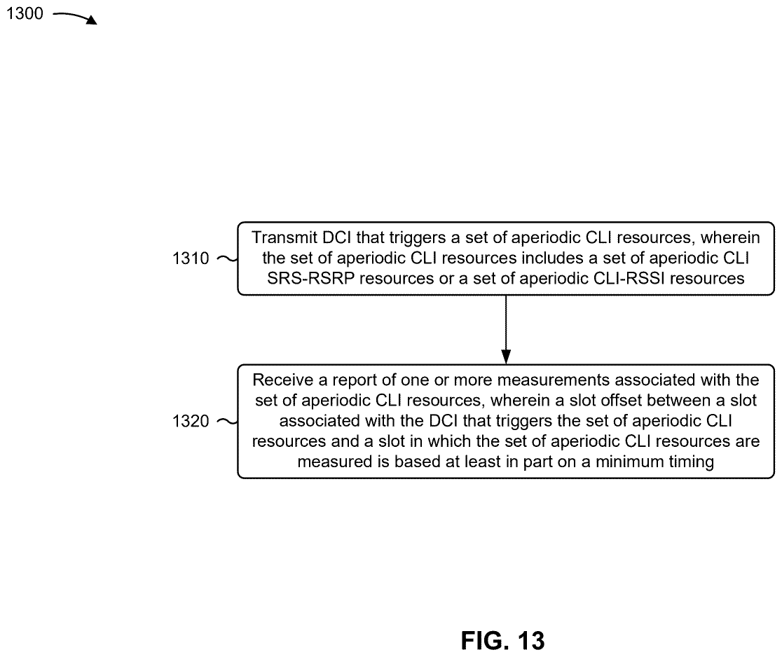

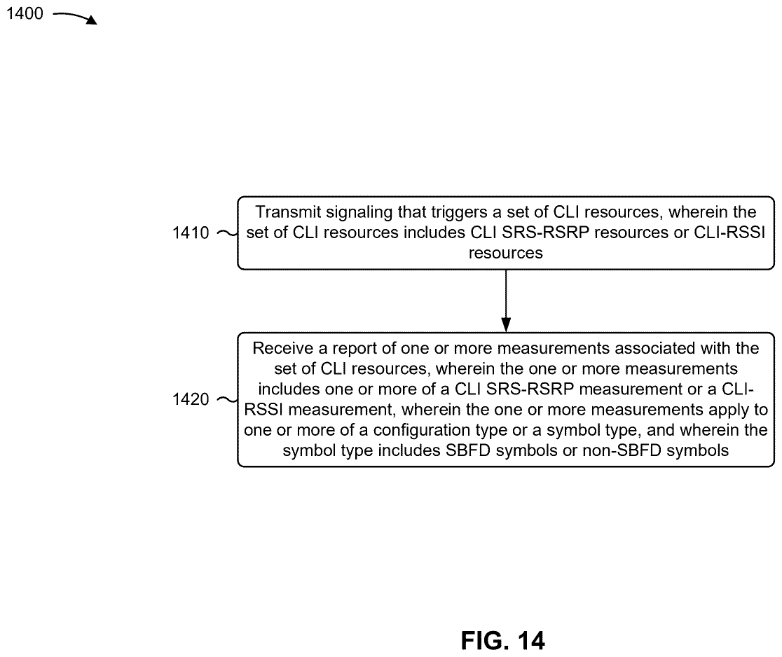

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with slot offsets for CLI measurement reporting, as described in more detail elsewhere herein. For example, the processing system 145 of the network node 110, the processing system 140 of the UE 120, the CU 210, the DU 230, or the RU 240 may perform or direct operations of, for example, process 1100 of FIG. 11, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

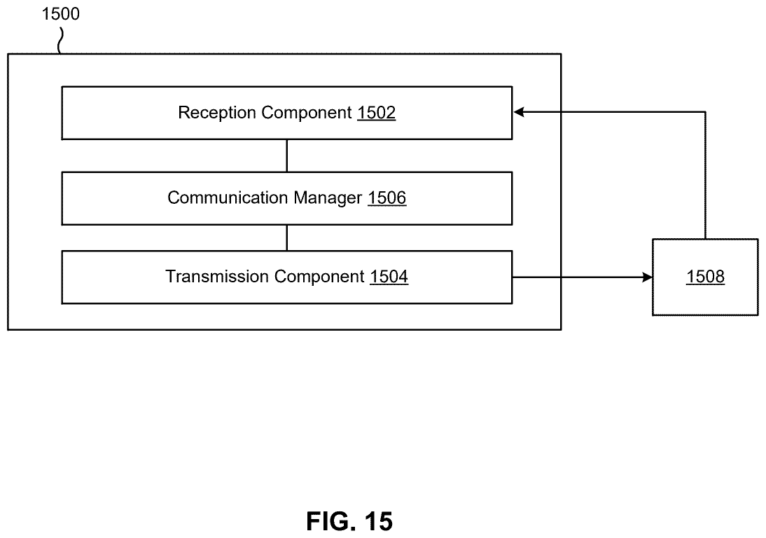

In some aspects, a UE (e.g., the UE 120) includes means for receiving DCI that triggers a set of aperiodic CLI resources, wherein the set of aperiodic CLI resources includes a set of aperiodic CLI SRS-RSRP resources or a set of aperiodic CLI-RSSI resources; and/or means for transmitting a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing. In some aspects, the UE includes means for receiving signaling that triggers a set of CLI resources, wherein the set of CLI resources includes CLI SRS-RSRP resources or CLI-RSSI resources; and/or means for transmitting a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

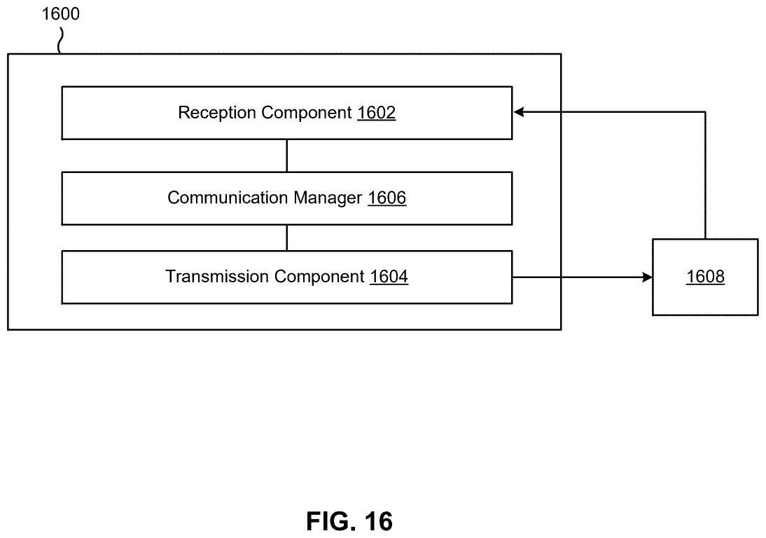

In some aspects, a network node (e.g., the network node 110) includes means for transmitting DCI that triggers a set of aperiodic CLI resources, wherein the set of aperiodic CLI resources includes a set of aperiodic CLI SRS-RSRP resources or a set of aperiodic CLI-RSSI resources; and/or means for receiving a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing. In some aspects, the network node includes means for transmitting signaling that triggers a set of CLI resources, wherein the set of CLI resources includes CLI SRS-RSRP resources or CLI-RSSI resources; and/or means for receiving a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols. The means for the network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

As indicated above, FIG. 2 is provided as an example. Other examples may differ from what is described with regard to FIG. 2.

A full duplex (FD) operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve a SBFD operation (or flexible duplex), in which a transmission and a reception may occur at the same time but on different frequency resources. A downlink resource may be separated from an uplink resource in a frequency domain. In the SBFD operation, no downlink and uplink overlap in frequency may occur.

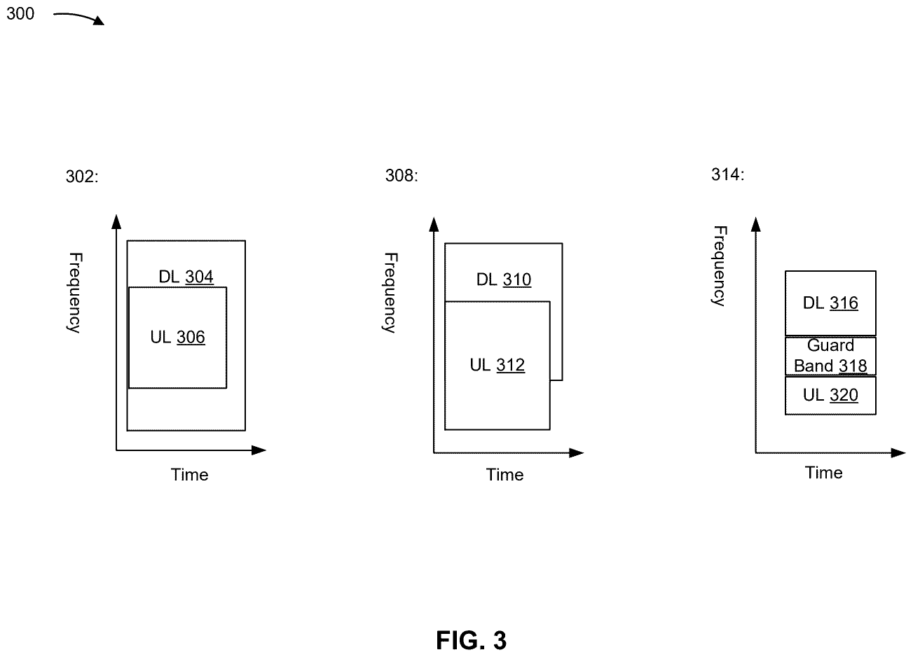

FIG. 3 is a diagram illustrating examples 300 of FD communications.

As shown by reference number 302, a downlink resource 304 and an uplink resource 306 may share the same IBFD time/frequency resource based at least in part on a full overlap. As shown by reference number 308, a downlink resource 310 and an uplink resource 312 may share the same IBFD time/frequency resource based at least in part on a partial overlap. As shown by reference number 314, a downlink resource 316 and an uplink resource 320 may be associated with a same time but different frequencies. The downlink resource 316 and the uplink resource 320 may be separated by a guard band 318.

As indicated above, FIG. 3 is provided as an example. Other examples may differ from what is described with regard to FIG. 3.

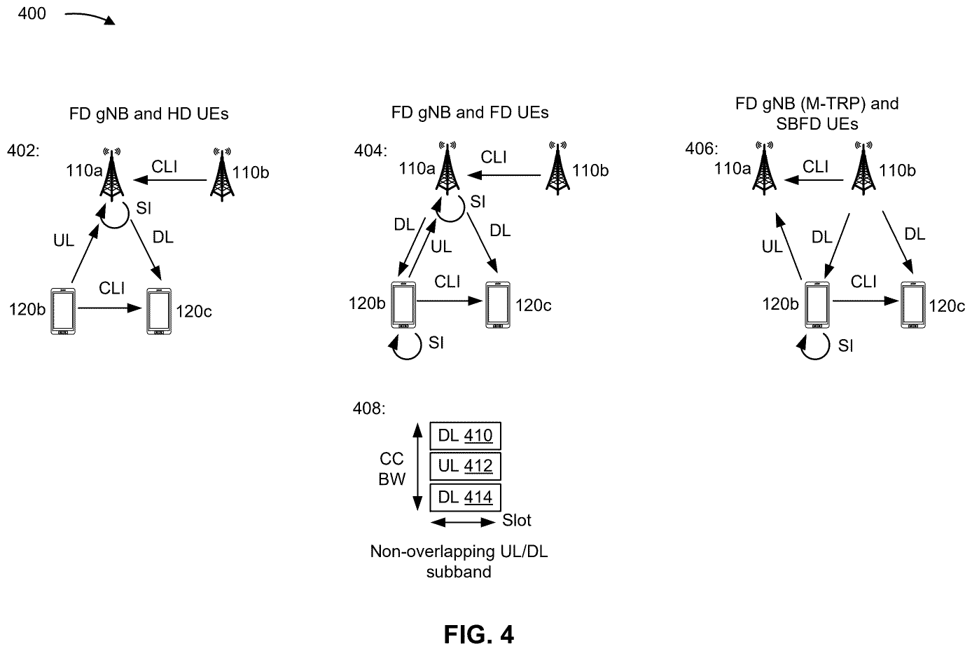

FIG. 4 is a diagram illustrating examples 400 of FD communications.

As shown by reference number 402, an FD network node (e.g., network node 110a) may communicate with half duplex (HD) UEs. The FD network node may be subjected to CLI from another FD network node (e.g., network node 110b). The CLI from the other FD network node may be inter-network node CLI. The FD network node may experience self-interference (SI). The FD network node may receive an uplink transmission from a first HD UE (e.g., UE 120b), and the FD network node may transmit a downlink transmission to a second HD UE (e.g., UE 120c). The FD network node may receive the uplink transmission and transmit the downlink transmission on the same slot (e.g., a simultaneous reception/transmission). The second HD UE may be subjected to CLI from the first HD UE (e.g., inter-UE CLI).

As shown by reference number 404, an FD network node (e.g., network node 110a) may communicate with FD UEs. The FD network node may be subjected to CLI from another FD network node (e.g., network node 110b). The FD network node may experience SI. The FD network node may transmit a downlink transmission to a first FD UE (e.g., UE 120b), and the FD network node may receive an uplink transmission from the first FD UE at the same time as the downlink transmission. The FD network node may transmit a downlink transmission to a second FD UE (e.g., UE 120c). The second HD UE may be subjected to CLI from the first HD UE. The first UE may experience SI.

As shown by reference number 406, a first FD network node (e.g., network node 110a), which may be associated with multiple transmission reception points (TRPs), may communicate with SBFD UEs. The first FD network node may be subjected to CLI from a second FD network node (e.g., network node 110b). The first FD network node may receive an uplink transmission from a first SBFD UE (e.g., UE 120b). The second FD network node may transmit downlink transmissions to both the first SBFD UE and a second SBFD UE (e.g., UE 120c). The second SBFD UE may be subjected to CLI from the first SBFD UE. The first SBFD UE may experience SI.

As shown by reference number 408, an SBFD slot may be associated with a non-overlapping uplink/downlink sub-band. The SBFD slot may be associated with a simultaneous transmission/reception of a downlink/uplink on a sub-band basis. Within a component carrier bandwidth, an uplink resource 412 may be in between, in a frequency domain, a first downlink resource 410 and a second downlink resource 414. The first downlink resource 410, the second downlink resource 414, and the uplink resource 412 may all be associated with the same time.

An SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible and dynamic uplink/downlink resource adaption according to uplink/downlink traffic in a robust manner.

As indicated above, FIG. 4 is provided as an example. Other examples may differ from what is described with regard to FIG. 4.

When a UE is operating in an HD mode and a network node is operating in an SBFD/IBFD mode, various sources of interference may be present for the UE. The UE may experience inter-cell interference from other network nodes. The UE may experience intra-cell CLI, which may be interference from UEs in the same cell. The UE may experience inter-cell CLI, which may be interference from UEs in adjacent cells. Further, when the UE is an FD UE, the UE may experience SI (e.g., a downlink transmission of the UE may cause interference to an uplink transmission associated with the UE, or vice versa). Inter-UE CLI handling may resolve intra-subband CLI and/or inter-subband CLI in the case of subband non-overlapping FD.

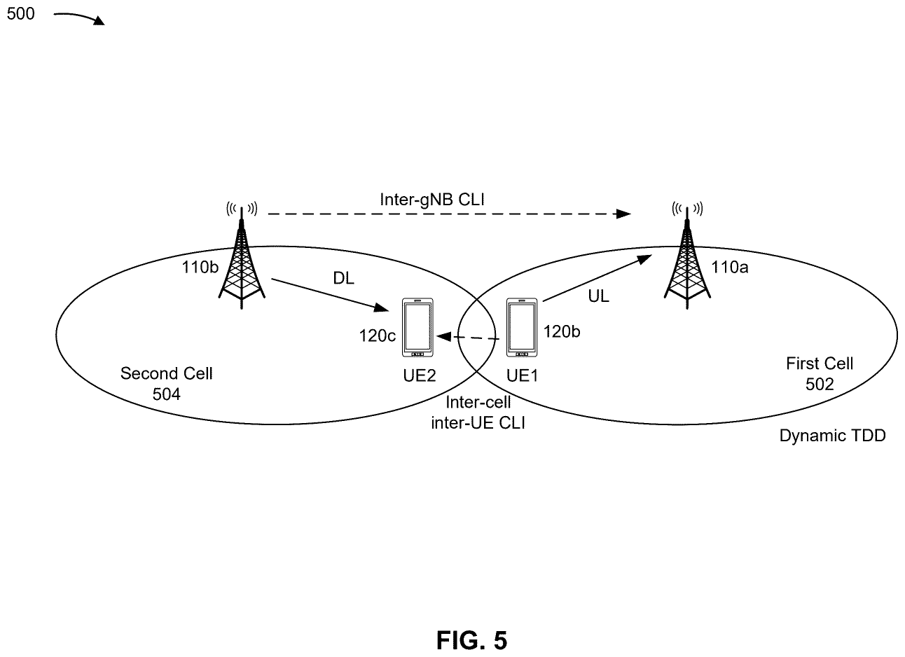

FIG. 5 is a diagram illustrating an example 500 of CLI.

As shown in FIG. 5, in a dynamic time domain duplexing (TDD) scenario, a first network node 110a in a first cell 502 may receive an uplink transmission from a first UE 120b. A second network node 110b in a second cell 504 may transmit a downlink transmission to a second UE 120c. The second UE 120c may experience interference from the first UE 120b. In other words, the first UE 120b may cause interference to the second UE 120c, where the interference may be based at least in part on the uplink transmission from the first UE 120b. The interference may be an inter-cell inter-UE CLI. Further, the first network node 110a may experience inter-network-node (e.g., inter-gNB) CLI from the second network node 110b.

As indicated above, FIG. 5 is provided as an example. Other examples may differ from what is described with regard to FIG. 5.

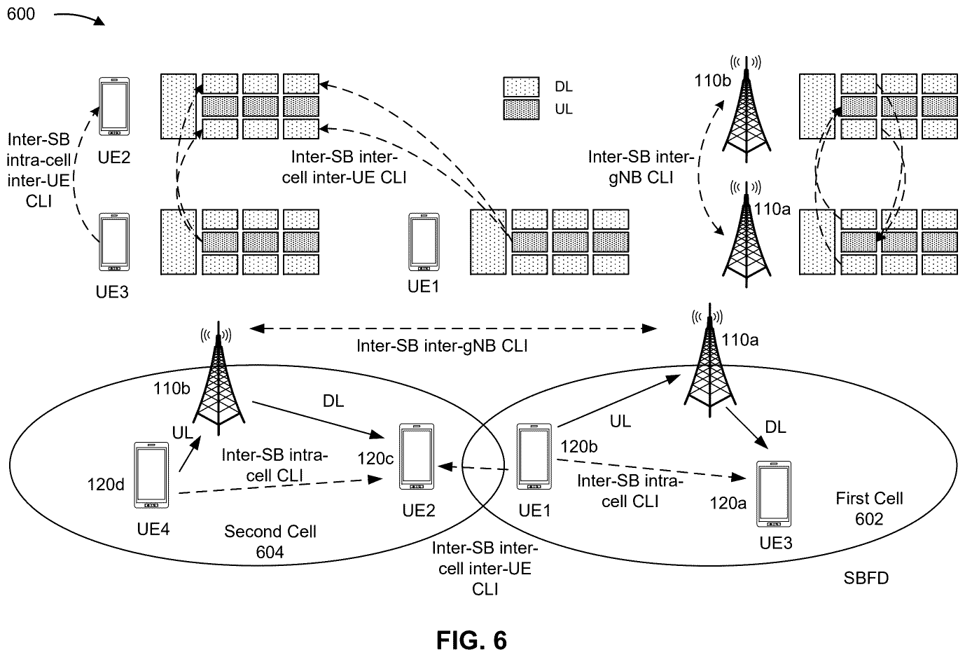

FIG. 6 is a diagram illustrating an example 600 of CLI.

As shown in FIG. 6, in an SBFD scenario, a first network node 110a in a first cell 602 may receive an uplink transmission from a first UE 120b in the first cell 602. The first network node 110a may transmit a downlink transmission to a third UE 120a in the first cell 602. The first UE 120b may cause an inter-subband (inter-SB) intra-cell CLI to the third UE 120a based at least in part on the uplink transmission of the first UE 120b. A second network node 110b in a second cell 604 may receive an uplink transmission from a fourth UE 120d in the second cell 604. The second network node 110b may transmit a downlink transmission to a second UE 120c in the second cell 604. The fourth UE 120d may cause an inter-SB intra-cell CLI to the second UE 120c based at least in part on the uplink transmission of the fourth UE 120d. The uplink transmission of the fourth UE 120d may cause the inter-SB intra-cell CLI to downlink transmissions of the second UE 120c. Further, the first UE 120b in the first cell 602 may cause an inter-SB inter-cell inter-UE CLI to the second UE 120c in the second cell 604 based at least in part on the uplink transmission of the first UE 120b. The uplink transmission of the first UE 120b may cause the inter-SB inter-cell inter-UE CLI to downlink transmissions of the second UE 120c. Further, the first network node 110a may cause an inter-SB inter-gNB CLI to the second network node 110b, and vice versa. Downlink transmissions of the first network node 110a may cause the inter-SB inter-gNB CLI to an uplink transmission of the second network node 110b. Downlink transmissions of the second network node 110b may cause the inter-SB inter-gNB CLI to an uplink transmission of the first network node 110a.

As indicated above, FIG. 6 is provided as an example. Other examples may differ from what is described with regard to FIG. 6.

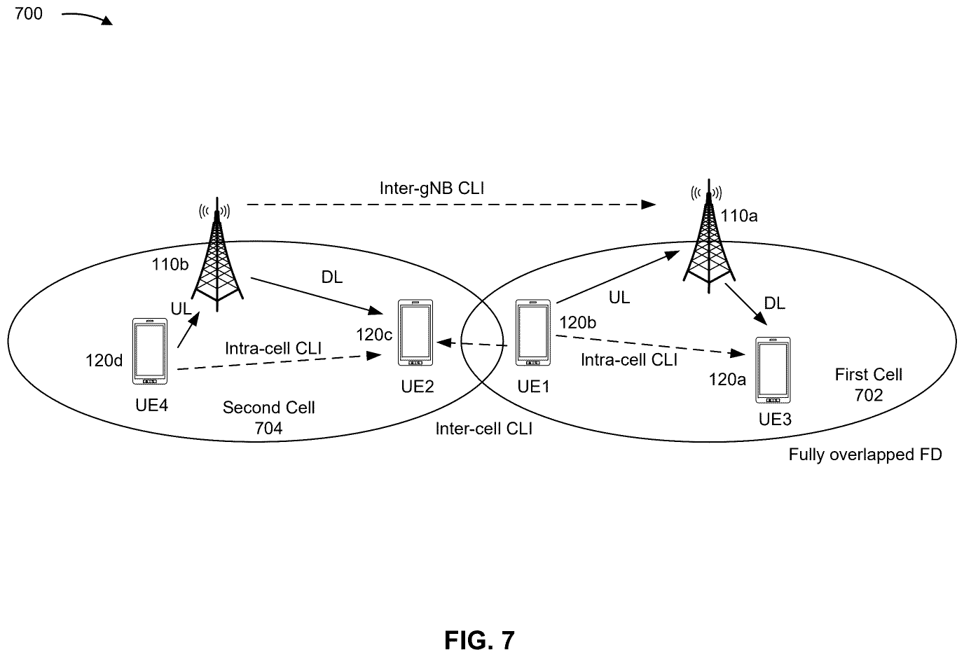

FIG. 7 is a diagram illustrating an example 700 of CLI.

As shown in FIG. 7, in a partially or fully overlapped FD scenario, a first network node 110a in a first cell 702 may receive an uplink transmission from a first UE 120b in the first cell 702. The first network node 110a may transmit a downlink transmission to a third UE 120a in the first cell 702. The first UE 120b may cause an intra-cell CLI to the third UE 120a based at least in part on the uplink transmission of the first UE 120b. A second network node 110b in a second cell 704 may receive an uplink transmission from a fourth UE 120d in the second cell 704. The second network node 110b may transmit a downlink transmission to a second UE 120c in the second cell 704. The fourth UE 120d may cause an intra-cell CLI to the second UE 120c based at least in part on the uplink transmission of the fourth UE 120d. Further, the first UE 120b in the first cell 702 may cause an inter-cell CLI to the second UE 120c in the second cell 704 based at least in part on the uplink transmission of the first UE 120b. Further, the first network node 110a may cause an in-band inter-gNB CLI to the second network node 110b, and vice versa.

As indicated above, FIG. 7 is provided as an example. Other examples may differ from what is described with regard to FIG. 7.

For inter-UE CLI, a layer 1 (L1) based UE-to-UE CLI measurement and reporting may be based at least in part on a CSI framework. The L1 based UE-to-UE CLI measurement and reporting may involve measurement resources. The measurement resources may include periodic, semi-persistent, or aperiodic measurement resources (or resource sets), e.g., SRS-RSRP resources or CLI-RSSI resources. The L1 based UE-to-UE CLI measurement and reporting may involve measurement reporting, which may include aperiodic, periodic, or semi-persistent reporting. Report quantities may include L1-SRS-RSRP, L1-CLI-RSSI, and/or measurement resource indices. Wideband reporting may be supported. The measurement reporting may include UCI bits generation and priority rules for multiple CSI reporting.

For inter-gNB CLI, an inter-gNB CLI enhancement may involve an information exchange of a semi-static cell-specific SBFD time and frequency location configuration, an information exchange of a measurement resource configuration, e.g., synchronization signal block (SSB) and/or periodic non-zero-power (NZP) CSI-RS, an information exchange of strongest DL beam information, and/or an information exchange of a CLI-mitigation request. The inter-gNB CLI enhancement may involve an uplink resource muting for a PUSCH. An indication or determination of the uplink resource muting for the PUSCH may be based at least in part on a semi-static configuration, assuming comb-2 for both DFT-S-OFDM and CP-OFDM in each allocated physical resource block (PRB) and up to two symbols in a time domain. The uplink resource muting for the PUSCH may involve a PUSCH resource mapping, e.g., rate matching around muted resource elements (REs). For the uplink resource muting for the PUSCH, every other RE may be muted in a frequency domain, in accordance with a comb-2 pattern. The uplink resource muting for the PUSCH may involve a UCI resource determination in symbols with muted REs. The uplink resource muting for the PUSCH may not apply for a message A (Msg A) PUSCH and a message 3 (Msg 3) PUSCH. The uplink resource muting for the PUSCH may apply for UEs in an RRC connected mode. The uplink resource muting for the PUSCH may be associated with an uplink resource muting pattern. The uplink resource muting pattern may be assumed to not overlap an uplink DMRS or a phase tracking reference signal (PTRS) in a same symbol. Power boosting may be assumed for REs in a symbol with uplink resource muting. A PUSCH transmit power may not change across symbols. The uplink resource muting for the PUSCH may be subject to a UE capability.

An L1 CLI measurement and reporting may be based at least in part on a slot offset for an aperiodic CLI RSSI/RSRP resource. For an aperiodic SRS-RSRP reporting using an aperiodic SRS-RSRP measurement resource set, a slot offset between a slot containing a DCI that triggers a set of aperiodic SRS-RSRP resources and a slot in which an SRS-RSRP resource set is measured may be configured by a higher layer parameter. The slot offset may be configured based at least in part on a legacy SRS resource set and/or an available slot offset list. For an aperiodic CLI-RSSI reporting using an aperiodic CLI-RSSI measurement resource set, a slot offset between a slot containing a DCI that triggers a set of aperiodic CLI-RSSI resources and a slot in which a CLI-RSSI resource set is measured may be configured by a higher layer parameter. At least for an SRS-RSRP measurement in an uplink subband of an SBFD symbol, when a UE measures an SRS-RSRP and/or a CLI-RSSI, a constant offset relative to a downlink reference timing in a serving cell may be applied. The constant offset value may be derived by a UE implementation. The constant offset value may be at least T_{c}×N_{TA,offset} offset, where T_{c} is a constant and basic time unit for NR and N_{TA,offset} is a timing advance offset.

An aggressor UE may transmit in an uplink subband of an SBFD symbol. A victim UE may measure an SRS-RSRP and/or a CLI-RSSI in the uplink subband of the SBFD symbol. The aggressor UE may transmit in accordance with an uplink timing. The victim UE, in order to measure the SRS-RSRP and/or the CLI-RSSI, may use an offset value to match the uplink timing associated with the aggressor UE. The victim UE may apply a constant offset relative to a downlink reference timing, which may allow the victim UE to measure the SRS-RSRP and/or a CLI-RSSI. The victim UE may switch from the downlink reference timing to a CLI measurement timing based at least in part on the constant offset. The CLI measurement timing for the victim UE may be associated with the uplink timing of the aggressor UE. However, in some cases, the victim UE may have an insufficient amount of time to switch between the downlink reference timing and the CLI measurement timing in order to perform an SRS-RSRP measurement and/or a CLI-RSSI measurement. For example, a slot that contains a DCI that triggers a set of aperiodic SRS-RSRP or CLI-RSSI resources and a slot in which an SRS-RSRP or CLI-RSSI resource set is measured may be the same slot (e.g., the DCI and the SRS-RSRP or CLI-RSSI resource set may be separated by 2 or 3 symbols within the same slot). When the DCI and the SRS-RSRP or CLI-RSSI resource set are associated with the same slot, the victim UE may not have sufficient time to switch from the downlink reference timing to the CLI measurement timing, which may prevent the UE from performing the SRS-RSRP measurement and/or the CLI-RSSI measurement, thereby degrading an overall system performance.

In various aspects of techniques and apparatuses described herein, a UE may receive, from a network node, DCI that triggers a set of aperiodic CLI resources. The set of aperiodic CLI resources may include a set of aperiodic CLI SRS-RSRP resources or a set of aperiodic CLI-RSSI resources. The UE may transmit, to the network node, a report of one or more measurements associated with the set of aperiodic CLI resources. A slot offset between a slot associated with the DCI that triggers the set of aperiodic CLI resources and a slot in which the set of aperiodic CLI resources are measured may be based at least in part on a minimum timing. The slot offset between the slot associated with the DCI that triggers the set of aperiodic CLI SRS-RSRP resources and the slot in which the set of aperiodic CLI SRS-RSRP resources are measured may be more than zero slots in accordance with the minimum timing (e.g., the slot offset may not be equal to zero slots). The minimum timing may be at least one slot to accommodate a timing switching for CLI measurement that occurs at a slot boundary. A switching time between a downlink reference timing and a CLI measurement timing to measure the set of aperiodic CLI resources may be based at least in part on the minimum timing.

In some aspects, by configuring the slot offset between the slot associated with the DCI that triggers the set of aperiodic CLI resources and the slot in which the set of aperiodic CLI resources are measured to be in accordance with the minimum timing, the UE may have sufficient time to perform and report the one or more measurements associated with the set of aperiodic CLI resources. The one or more measurements may include CLI SRS-RSRP measurements and/or CLI-RSSI measurements. The slot associated with the DCI that triggers the set of aperiodic CLI resources and the slot in which the set of aperiodic CLI resources are measured may be different slots, which may allow the UE to accurately perform and report the one or more measurements. The network node may be able to use the one or more measurements to perform a CLI mitigation, thereby improving an overall system performance.

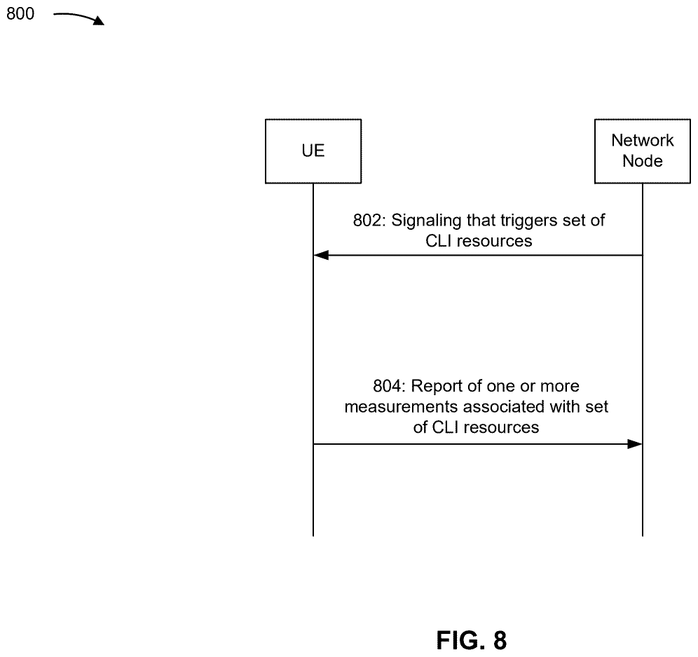

FIG. 8 is a diagram illustrating an example 800 associated with slot offsets for CLI measurement reporting. As shown in FIG. 8, example 800 includes communication between a UE (e.g., UE 120) and a network node (e.g., network node 110). In some aspects, the UE and the network node may be included in a wireless network, such as wireless network 100.

As shown by reference number 802, the UE may receive, from the network node, signaling such as DCI that triggers a set of CLI resources, such as a set of aperiodic CLI resources. The set of aperiodic CLI resources may include a set of aperiodic CLI SRS-RSRP resources or a set of aperiodic CLI-RSSI resources. The set of aperiodic CLI resources may include time/frequency domain resources that are to be used for a CLI measurement reporting.

As shown by reference number 804, the UE may transmit, to the network node, a report of one or more measurements associated with the set of aperiodic CLI resources. A slot offset between a slot associated with the DCI that triggers the set of aperiodic CLI resources and a slot in which the set of aperiodic CLI resources may be measured is based at least in part on a minimum timing.

In some aspects, the slot offset between the slot associated with the DCI that triggers the set of aperiodic CLI SRS-RSRP resources and the slot in which the set of aperiodic CLI SRS-RSRP resources are measured may be more than zero slots in accordance with the minimum timing. In some aspects, the slot offset between the slot associated with the DCI that triggers the set of aperiodic CLI-RSSI resources and the slot in which the set of aperiodic CLI-RSSI resources are measured may not be equal to zero slots in accordance with the minimum timing. In some aspects, the minimum timing may be at least one slot to accommodate a timing switching for CLI measurement that occurs at a slot boundary. In some aspects, the UE may transmit, to the network node, an indication of a UE capability of a minimum slot offset supported by the UE. The minimum timing may be based at least in part on the indication of the UE capability. In some aspects, a switching time between a downlink reference timing and a CLI measurement timing to measure the set of aperiodic CLI resources may be based at least in part on the minimum timing. The CLI measurement timing may be based at least in part on a constant offset value that is applied to the downlink reference timing in a serving cell. The constant offset value may be based at least in part on a UE implementation and may be at least a constant value multiplied by a timing advance offset.

In some aspects, the UE (e.g., a victim UE) may measure an SRS-RSRP and/or a CLI-RSSI in an uplink subband of an SBFD symbol. The UE may switch from a downlink reference timing to a CLI measurement timing in order to perform an SRS-RSRP measurement and/or a CLI-RSSI measurement. The UE may switch from the downlink timing to the CLI measurement timing in accordance with a minimum timing switch. The minimum timing switch may be based at least in part on a slot offset configuration rule. In some aspects, a slot offset between a slot containing a DCI that triggers a set of aperiodic CLI SRS-RSRP resources and a slot in which a CLI SRS-RSRP resource set is measured may be more than zero (e.g., the slot offset may not be zero), in accordance with a rule in a specification. The slot containing the DCI and the slot containing the SRS-RSRP resource set may be different slots, which may ensure that the UE has sufficient time to switch between the downlink reference timing and the CLI measurement timing. In some aspects, a slot offset between a slot containing a DCI that triggers a set of aperiodic CLI-RSSI resources and a slot in which a CLI-RSSI resource set is measured may be more than zero (e.g., the slot offset may not be zero), in accordance with a rule in a specification. The slot containing the DCI and the slot containing the CLI-RSSI resource set may be different slots, which may ensure that the UE has sufficient time to switch between the downlink reference timing and the CLI measurement timing.

In some aspects, in a UE implementation, a timing switch may occur at a slot boundary. In this case, a Z-Z′ gap time between a triggering DCI and a CLI resource may be more than one slot or equal to one slot, which may guarantee the timing switch when the timing switch occurs at the slot boundary. Z may define a latency from a DCI triggering to a reporting. Z′ may define a latency from a DCI triggering to a CLI resource (e.g., a measurement resource). The Z-Z′ gap time may be associated with a slot offset. Z and Z′ may be kept as a minimum requirement. An actual value may be larger than the minimum requirement. A slot offset may be greater than or equal to one slot in accordance with a rule in a specification.

In some aspects, the UE may indicate, to the network node, a UE capability regarding a minimum slot offset that is supported by the UE. For example, the UE may indicate that the UE supports a minimum of one slot for a CLI SRS-RSRP resource set and/or a CLI-RSSI resource set, in accordance with a UE implementation. As another example, the UE may indicate that the UE supports zero slots for a CLI SRS-RSRP resource set and/or a CLI-RSSI resource set, in accordance with a UE implementation. In this example, the minimum slot offset (or minimum timing switch) may be indicated by the UE rather than being defined in a specification.

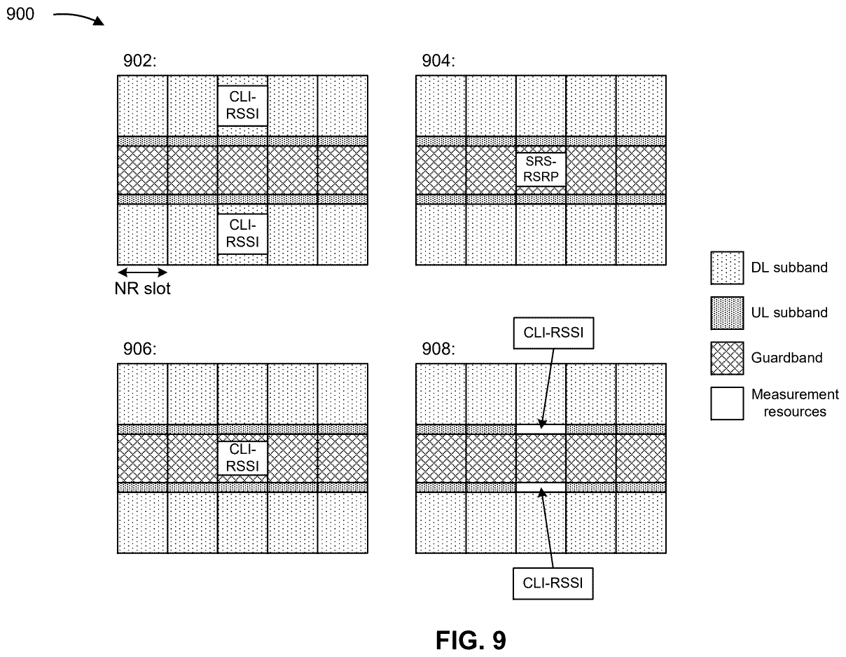

In some aspects, regarding L1 UE-to-UE CLI measurements and reporting in SBFD symbols, the UE may perform CLI measurements within an active downlink BWP. The UE may measure an RSSI within a downlink subband. The UE may measure an RSRP of an aggressor UE within an uplink subband. The UE may measure an RSSI within an uplink subband. For an L1 CLI-RSSI measurement, the UE may measure the RSSI within the downlink subband based at least in part on a downlink timing. Examples of L1 UE-to-UE CLI measurements in SBFD symbols are shown in FIG. 9.

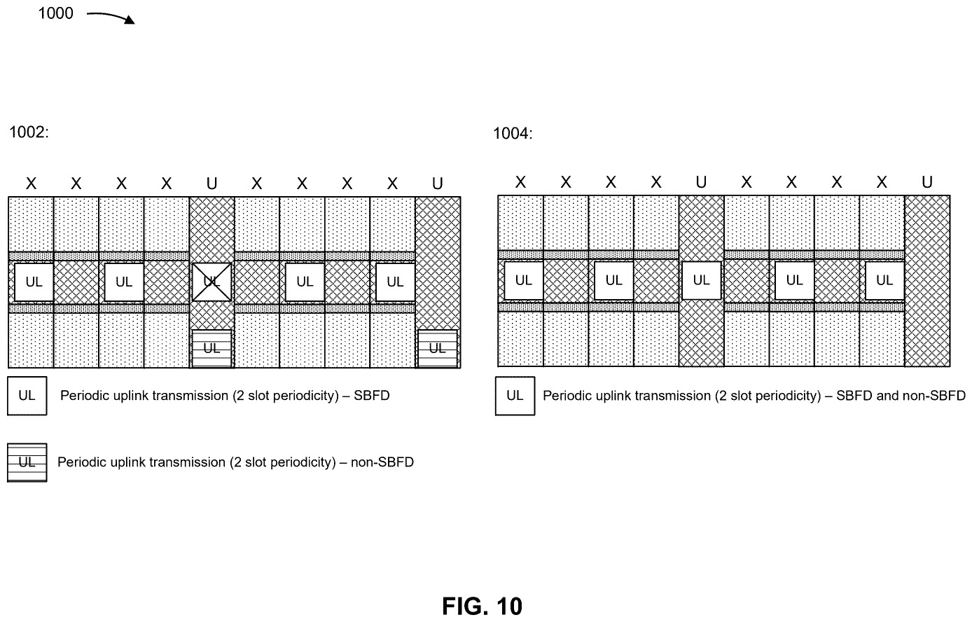

In some aspects, for uplink transmissions and downlink receptions across SBFD symbols and non-SBFD symbols in different slots (e.g., each uplink transmission or downlink reception within a slot may have either all SBFD symbols or all non-SBFD symbols), an SBFD-aware UE may be provided with a first configuration or a second configuration. In the first configuration, the uplink transmissions and/or the downlink receptions may be restricted to only SBFD symbols or only non-SBFD symbols. In the second configuration, the uplink transmissions and/or the downlink receptions may be in SBFD symbols and non-SBFD symbols. Examples of SBFD transmissions and/or receptions across SBFD symbols and non-SBFD symbols in accordance with different configurations are shown in FIG. 10.

In some aspects, the UE may receive, from the network node, signaling that triggers the set of CLI resources, where the set of CLI resources may include CLI SRS-RSRP resources or CLI-RSSI resources. The signaling may include DCI that triggers aperiodic CLI resources. The signaling may include an RRC configuration that triggers periodic CLI resources. The signaling may include a MAC-CE that triggers semi-persistent CLI resources. The UE may transmit, to the network node, a report of one or more measurements associated with the set of CLI resources. The one or more measurements may include a CLI SRS-RSRP measurement and/or a CLI-RSSI measurement. The one or more measurements may apply to a configuration type and/or a symbol type. The symbol type may include SBFD symbols or non-SBFD symbols.

In some aspects, the configuration type may be a first configuration type that restricts the CLI SRS-RSRP measurement or the CLI-RSSI measurement to the SBFD symbols or the non-SBFD symbols, or the configuration type may be a second configuration type that allows the CLI SRS-RSRP measurement or the CLI-RSSI measurement to be in the SBFD symbols and the non-SBFD symbols. In some aspects, the CLI SRS-RSRP measurement or the CLI-RSSI measurement may apply to the SBFD symbols. In some aspects, the CLI SRS-RSRP measurement or the CLI-RSSI measurement may apply to a configuration type that restricts the CLI SRS-RSRP measurement or the CLI-RSSI measurement to the SBFD symbols or the non-SBFD symbols, and the CLI SRS-RSRP measurement or the CLI-RSSI measurement may be restricted to the SBFD symbols. In some aspects, a valid symbol type associated with the CLI SRS-RSRP measurement or the CLI-RSSI measurement may be an SBFD symbol type.

In some aspects, CLI measurements in SBFD symbols may be based at least in part on RSSI measurements within a downlink subband, RSRP measurements of an aggressor UE within an uplink subband, and/or RSSI measurements within the uplink subband. Uplink transmissions and/or downlink receptions may be restricted to only SBFD symbols or only non-SBFD symbols in accordance with the first configuration. Uplink transmissions and/or downlink receptions may be in SBFD symbols and non-SBFD symbols in accordance with the second configuration. In some aspects, a CLI SRS-RSRP measurement and/or a CLI-RSSI measurement may apply to the first configuration and/or the second configuration. In some aspects, the CLI SRS-RSRP measurement and/or the CLI-RSSI measurement may apply to SBFD symbols and/or non-SBFD symbols.

In some aspects, the CLI SRS-RSRP measurement or the CLI-RSSI measurement may only apply to SBFD symbols. In some aspects, the CLI SRS-RSRP measurement or the CLI-RSSI measurement may only apply to the first configuration, which may restrict the uplink transmissions and/or the downlink receptions to only one symbol type. The CLI SRS-RSRP measurement or the CLI-RSSI measurement may not apply the second configuration. For the CLI SRS-RSRP measurement or the CLI-RSSI measurement, the uplink transmissions and/or the downlink receptions may be restricted to only SBFD symbols (e.g., the symbol type may only be SBFD). In some aspects, for the CLI SRS-RSRP measurement or the CLI-RSSI measurement, a valid symbol type may only be an SBFD symbol type (e.g., non-SBFD symbols may be invalid).

In some aspects, the CLI SRS-RSRP measurement or the CLI-RSSI measurement may apply to a configuration type that restricts the CLI SRS-RSRP measurement or the CLI-RSSI measurement to the SBFD symbols or the non-SBFD symbols, and the CLI SRS-RSRP measurement or the CLI-RSSI measurement may be restricted to the SBFD symbols or the non-SBFD symbols. In some aspects, the CLI SRS-RSRP measurement or the CLI-RSSI measurement may apply to the SBFD symbols or the non-SBFD symbols. In some aspects, the UE may receive, from the network node via RRC signaling, an indication of a valid symbol type associated with a CLI measurement. The valid symbol type may be defined in a CLI SRS-RSRP measurement resource set or a CLI-RSSI measurement resource set. In some aspects, the UE may receive, from the network node via RRC signaling, a CLI report configuration that indicates a valid symbol type associated with a CLI measurement. In some aspects, a valid symbol type associated with a CLI measurement may be based at least in part on a first CLI SRS-RSRP measurement occasion or a first CLI-RSSI measurement occasion. The first CLI SRS-RSRP measurement occasion or the first CLI-RSSI measurement occasion may be after a slot offset for an aperiodic triggered CLI resource. The first CLI SRS-RSRP measurement occasion or the first CLI-RSSI measurement occasion may be after a MAC-CE activation for a semi-persistent CLI resource.

In some aspects, the CLI SRS-RSRP measurement or the CLI-RSSI measurement may only apply to the first configuration, which may restrict the uplink transmissions and/or the downlink receptions to only one symbol type. The CLI SRS-RSRP measurement or the CLI-RSSI measurement may not apply to the second configuration. For the CLI SRS-RSRP measurement or the CLI-RSSI measurement, the uplink transmissions and/or the downlink receptions may be restricted to only SBFD symbols (e.g., the symbol type may only be SBFD) or the uplink transmissions, and/or the downlink receptions may be restricted to only non-SBFD symbols (e.g., the symbol type may only be non-SBFD). In some aspects, the CLI SRS-RSRP measurement or the CLI-RSSI measurement may apply to SBFD symbols or non-SBFD symbols.

In some aspects, the UE may receive, from the network node, an indication signaling of a symbol type. In some aspects, the UE may receive, via RRC signaling, an indication of a CLI SRS-RSRP measurement resource set or a CLI-RSSI measurement resource set, where the indication may indicate the symbol type. In some aspects, the UE may receive, via RRC signaling, a CLI report configuration, which may indicate the symbol type. In some aspects, when a measurement resource (e.g., a CLI SRS-RSRP measurement resource or a CLI-RSSI measurement resource) is an aperiodic resource or a semi-persistent resource, a valid symbol type may be based at least in part on a first reception measurement occasion in accordance with a rule. When the measurement resource is the semi-persistent resource, the valid symbol type may be a first reception measurement occasion after a MAC-CE activation, in accordance with the rule. When the measurement resource is the aperiodic resource, the valid symbol type may be a first reception measurement occasion after a slot offset for an aperiodic triggering, in accordance with the rule.

In some aspects, the CLI SRS-RSRP measurement or the CLI-RSSI measurement may apply to a configuration type that allows the CLI SRS-RSRP measurement or the CLI-RSSI measurement to be in the SBFD symbols and the non-SBFD symbols, and the CLI SRS-RSRP measurement or the CLI-RSSI measurement may be in the SBFD symbols and the non-SBFD symbols. In some aspects, CLI SRS-RSRP measurements or CLI-RSSI measurements may not be averaged between the SBFD symbols and the non-SBFD symbols. In some aspects, the set of CLI resources may include wideband CLI SRS-RSRP resources or the CLI-RSSI resources, and a downlink subband CLI measurement or an uplink subband CLI measurement may be applied in one or more SBFD symbols based on a predefined rule.

In some aspects, the CLI SRS-RSRP measurement or the CLI-RSSI measurement may apply to the second configuration, which may allow the uplink transmissions and/or the downlink receptions to be in SBFD symbols and non-SBFD symbols. CLI SRS-RSRP measurements and CLI-RSSI measurements may not be averaged between SBFD symbols and non-SBFD symbols. A time restriction (timeRestriction) parameter may be configured to be on, which may cause the CLI SRS-RSRP measurements and the CLI-RSSI measurements to not be averaged between SBFD symbols and non-SBFD symbols. An amount of CLI may be different for SBFD symbols versus non-SBFD symbols due to inter-cell measurements, so the CLI SRS-RSRP measurements and the CLI-RSSI measurements may not be averaged between SBFD symbols and non-SBFD symbols. The CLI SRS-RSRP measurement or the CLI-RSSI measurement may apply to the SBFD symbols or the non-SBFD symbols. When a wideband CLI SRS-RSRP measurement resource or a wideband CLI-RSSI measurement resource is configured (e.g., for non-SBFD symbols), the UE may implicitly apply a downlink subband or uplink subband CLI measurement in SBFD symbols.

In some aspects, the report may be a CLI SRS-RSRP report or a CLI-RSSI report. In some aspects, each SBFD symbol type or non-SBFD symbol type may be independently reported via the report, and two report quantities may be configured in a report configuration to report CLI separately for each symbol type. In some aspects, each SBFD symbol type or non-SBFD symbol type may be independently reported via the report. One report quantity may be configured in a report configuration. Each report may be based at least in part on one symbol type that corresponds to a type of reference resource. In some aspects, each SBFD symbol type or non-SBFD symbol type may be independently reported via the report. One report quantity may be configured in a report configuration. The report may indicate a latest measurement occasion with a corresponding symbol type.

In some aspects, for a CLI SRS-RSRP or CLI-RSSI measurement reporting, the UE may independently report each non-SBFD or SBFD symbol type, where two report quantities (reportQuantities) may be configured in a report configuration (reportConfig) to report CLI separately in each symbol type. In some aspects, for the CLI SRS-RSRP or CLI-RSSI measurement reporting, the UE may independently report each non-SBFD or SBFD symbol type with one report quantity configured. Each UE report may be based at least in part on only one symbol type that is the same as the type of reference resource, which may be defined as an offset to a slot carrying a UCI report. In some aspects, for the CLI SRS-RSRP or CLI-RSSI measurement reporting, the UE may independently report each non-SBFD or SBFD symbol type with one report quantity configured, where the UE may report a latest measurement occasion with a corresponding symbol type (e.g., the UE may always report the latest measurement occasion with the corresponding symbol type).

As indicated above, FIG. 8 is provided as an example. Other examples may differ from what is described with regard to FIG. 8.

FIG. 9 is a diagram illustrating an example 900 of CLI measurements.

As shown by reference number 902, a first CLI-RSSI measurement resource may be associated with a first downlink sub-band and a second CLI-RSSI measurement resource may be associated with a second downlink sub-band. The first downlink sub-band and the second downlink sub-band may be associated with a same NR slot (e.g., an SBFD slot). As shown by reference number 904, a CLI-RSRP measurement resource may be associated with an uplink sub-band of an NR slot (e.g., an SBFD slot). As shown by reference number 906, a CLI-RSSI measurement resource may be associated with an uplink sub-band of an NR slot (e.g., an SBFD slot). As shown by reference number 908, a first CLI-RSSI measurement resource may be associated with a first guard band and a second CLI-RSSI measurement resource may be associated with a second guard band. The first guard band and the second guard band may be associated with a same NR slot (e.g., an SBFD slot).

As indicated above, FIG. 9 is provided as an example. Other examples may differ from what is described with regard to FIG. 9.

FIG. 10 is a diagram illustrating an example 1000 of uplink transmissions or downlink receptions across SBFD symbols and non-SBFD symbols.

As shown by reference number 1002, uplink transmissions and/or downlink receptions may be restricted to only SBFD symbols or only non-SBFD symbols in accordance with a first configuration. For example, first periodic uplink transmissions with a two slot periodicity may be restricted to only SBFD symbols. As another example, second periodic uplink transmissions with a two slot periodicity may be restricted to only non-SBFD symbols (e.g., uplink-only symbols). As shown by reference number 1004, uplink transmissions and/or downlink receptions may be in SBFD symbols and non-SBFD symbols in accordance with a second configuration. For example, periodic uplink transmissions with a two slot periodicity may be in SBFD symbols and non-SBFD symbols.

As indicated above, FIG. 10 is provided as an example. Other examples may differ from what is described with regard to FIG. 10.

FIG. 11 is a diagram illustrating an example process 1100 performed, for example, at a UE or an apparatus of a UE. Example process 1100 is an example where the apparatus or the UE (e.g., UE 120) performs operations associated with slot offsets for CLI measurement reporting.

As shown in FIG. 11, in some aspects, process 1100 may include receiving DCI that triggers a set of aperiodic CLI resources, wherein the set of aperiodic CLI resources includes a set of aperiodic CLI SRS-RSRP resources or a set of aperiodic CLI-RSSI resources (block 1110). For example, the UE (e.g., using reception component 1502 or communication manager 1506, depicted in FIG. 15) may receive DCI that triggers a set of aperiodic CLI resources, wherein the set of aperiodic CLI resources includes a set of aperiodic CLI SRS-RSRP resources or a set of aperiodic CLI-RSSI resources, as described above in connection with reference number 1002 in FIG. 10.

As further shown in FIG. 11, in some aspects, process 1100 may include transmitting a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing (block 1120). For example, the UE (e.g., using transmission component 1504 or communication manager 1506, depicted in FIG. 15) may transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing, as described above in connection with reference number 1004 in FIG. 10.

Process 1100 may include additional aspects, such as any single aspect or any combination of aspects described below or in connection with one or more other processes described elsewhere herein.

In a first aspect, the slot offset between the slot associated with the DCI that triggers the set of aperiodic CLI SRS-RSRP resources and the slot in which the set of aperiodic CLI SRS-RSRP resources are measured is more than zero slots in accordance with the minimum timing.

In a second aspect, alone or in combination with the first aspect, the slot offset between the slot associated with the DCI that triggers the set of aperiodic CLI-RSSI resources and the slot in which the set of aperiodic CLI-RSSI resources are measured is not equal to zero slots in accordance with the minimum timing.

In a third aspect, alone or in combination with one or more of the first and second aspects, the minimum timing is at least one slot to accommodate a timing switching for CLI measurement that occurs at a slot boundary.

In a fourth aspect, alone or in combination with one or more of the first through third aspects, process 1100 includes transmitting an indication of a UE capability of a minimum slot offset supported by the UE, wherein the minimum timing is based at least in part on the indication of the UE capability.

In a fifth aspect, alone or in combination with one or more of the first through fourth aspects, a switching time between a downlink reference timing and a CLI measurement timing to measure the set of aperiodic CLI resources is based at least in part on the minimum timing.

In a sixth aspect, alone or in combination with one or more of the first through fifth aspects, the CLI measurement timing is based at least in part on a constant offset relative that is applied to the downlink reference timing in a serving cell, and the constant offset value is based at least in part on a UE implementation and is at least a constant value multiplied by a timing advance offset.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a UE or an apparatus of a UE. Example process 1200 is an example where the apparatus or the UE (e.g., UE 120) performs operations associated with slot offsets for CLI measurement reporting.

As shown in FIG. 12, in some aspects, process 1200 may include receiving signaling that triggers a set of CLI resources, wherein the set of CLI resources includes CLI SRS-RSRP resources or CLI-RSSI resources (block 1210). For example, the UE (e.g., using reception component 1502 or communication manager 1506, depicted in FIG. 15) may receive signaling that triggers a set of CLI resources, wherein the set of CLI resources includes CLI SRS-RSRP resources or CLI-RSSI resources, as described above in connection with reference number 1002 in FIG. 10.

As further shown in FIG. 12, in some aspects, process 1200 may include transmitting a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols (block 1220). For example, the UE (e.g., using transmission component 1504 or communication manager 1506, depicted in FIG. 15) may transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols, as described above in connection with reference number 1004 in FIG. 10.

Process 1200 may include additional aspects, such as any single aspect or any combination of aspects described below or in connection with one or more other processes described elsewhere herein.

In a first aspect, the configuration type is a first configuration type that restricts the CLI SRS-RSRP measurement or the CLI-RSSI measurement to the SBFD symbols or the non-SBFD symbols, or the configuration type is a second configuration type that allows the CLI SRS-RSRP measurement or the CLI-RSSI measurement to be in the SBFD symbols and the non-SBFD symbols.

In a second aspect, alone or in combination with the first aspect, the CLI SRS-RSRP measurement or the CLI-RSSI measurement applies to the SBFD symbols.

In a third aspect, alone or in combination with one or more of the first and second aspects, the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and the CLI SRS-RSRP measurement or the CLI-RSSI measurement are restricted to the SBFD symbols.

In a fourth aspect, alone or in combination with one or more of the first through third aspects, a valid symbol type associated with the CLI SRS-RSRP measurement or the CLI-RSSI measurement is an SBFD symbol type.

In a fifth aspect, alone or in combination with one or more of the first through fourth aspects, the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and the CLI SRS-RSRP measurement or the CLI-RSSI measurement are restricted to the SBFD symbols or the non-SBFD symbols.

In a sixth aspect, alone or in combination with one or more of the first through fifth aspects, the CLI SRS-RSRP measurement or the CLI-RSSI measurement applies to the SBFD symbols or the non-SBFD symbols.

In a seventh aspect, alone or in combination with one or more of the first through sixth aspects, process 1200 includes receiving, via RRC signaling, an indication of a valid symbol type associated with a CLI measurement, wherein the valid symbol type is defined in a CLI SRS-RSRP measurement resource set or a CLI-RSSI measurement resource set.

In an eighth aspect, alone or in combination with one or more of the first through seventh aspects, process 1200 includes receiving, via RRC signaling, a CLI report configuration that indicates a valid symbol type associated with a CLI measurement.

In a ninth aspect, alone or in combination with one or more of the first through eighth aspects, a valid symbol type associated with a CLI measurement is based at least in part on a first CLI SRS-RSRP measurement occasion or a first CLI-RSSI measurement occasion.

In a tenth aspect, alone or in combination with one or more of the first through ninth aspects, the first CLI SRS-RSRP measurement occasion or the first CLI-RSSI measurement occasion is after a slot offset for an aperiodic triggered CLI resource.

In an eleventh aspect, alone or in combination with one or more of the first through tenth aspects, the first CLI SRS-RSRP measurement occasion or the first CLI-RSSI measurement occasion is after a MAC-CE activation for a semi-persistent CLI resource.

In a twelfth aspect, alone or in combination with one or more of the first through eleventh aspects, the CLI SRS-RSRP measurement or the CLI-RSSI measurement applies to a configuration type that allows the CLI SRS-RSRP measurement or the CLI-RSSI measurement to be in the SBFD symbols and the non-SBFD symbols, and the CLI SRS-RSRP measurement or the CLI-RSSI measurement are in the SBFD symbols and the non-SBFD symbols.

In a thirteenth aspect, alone or in combination with one or more of the first through twelfth aspects, CLI SRS-RSRP measurements or CLI-RSSI measurements are not averaged between the SBFD symbols and the non-SBFD symbols.

In a fourteenth aspect, alone or in combination with one or more of the first through thirteenth aspects, the set of CLI resources includes wideband CLI SRS-RSRP resources or the CLI-RSSI resources, and a downlink subband CLI measurement or an uplink subband CLI measurement is applied in one or more SBFD symbols based on a predefined rule.

In a fifteenth aspect, alone or in combination with one or more of the first through fourteenth aspects, the report is a CLI SRS-RSRP report or a CLI-RSSI report.

In a sixteenth aspect, alone or in combination with one or more of the first through fifteenth aspects, each SBFD symbol type or non-SBFD symbol type is independently reported via the report, and two report quantities are configured in a report configuration to report CLI separately for each symbol type.

In a seventeenth aspect, alone or in combination with one or more of the first through sixteenth aspects, each SBFD symbol type or non-SBFD symbol type is independently reported via the report, wherein one report quantity is configured in a report configuration, and each report is based at least in part on one symbol type that corresponds to a type of reference resource.

In an eighteenth aspect, alone or in combination with one or more of the first through seventeenth aspects, each SBFD symbol type or non-SBFD symbol type is independently reported via the report, wherein one report quantity is configured in a report configuration, and the report indicates a latest measurement occasion with a corresponding symbol type.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node. Example process 1300 is an example where the apparatus or the network node (e.g., network node 110) performs operations associated with slot offsets for CLI measurement reporting.

As shown in FIG. 13, in some aspects, process 1300 may include transmitting DCI that triggers a set of aperiodic CLI resources, wherein the set of aperiodic CLI resources includes a set of aperiodic CLI SRS-RSRP resources or a set of aperiodic CLI-RSSI resources (block 1310). For example, the network node (e.g., using transmission component 1604 or communication manager 1606, depicted in FIG. 16) may transmit DCI that triggers a set of aperiodic CLI resources, wherein the set of aperiodic CLI resources includes a set of aperiodic CLI SRS-RSRP resources or a set of aperiodic CLI-RSSI resources, as described above in connection with reference number 1002 in FIG. 10.

As further shown in FIG. 13, in some aspects, process 1300 may include receiving a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing (block 1320). For example, the network node (e.g., using reception component 1602 or communication manager 1606, depicted in FIG. 16) may receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing, as described above in connection with reference number 1004 in FIG. 10.

Process 1300 may include additional aspects, such as any single aspect or any combination of aspects described below or in connection with one or more other processes described elsewhere herein.

In a first aspect, the slot offset between the slot associated with the DCI that triggers the set of aperiodic CLI SRS-RSRP resources and the slot in which the set of aperiodic CLI SRS-RSRP resources are measured is more than zero slots in accordance with the minimum timing.

In a second aspect, alone or in combination with the first aspect, the slot offset between the slot associated with the DCI that triggers the set of aperiodic CLI-RSSI resources and the slot in which the set of aperiodic CLI-RSSI resources are measured is not equal to zero slots in accordance with the minimum timing.

In a third aspect, alone or in combination with one or more of the first and second aspects, the minimum timing is at least one slot to accommodate a timing switching for CLI measurement that occurs at a slot boundary.

In a fourth aspect, alone or in combination with one or more of the first through third aspects, process 1300 includes receiving an indication of a UE capability of a minimum slot offset supported by the UE, wherein the minimum timing is based at least in part on the indication of the UE capability.

In a fifth aspect, alone or in combination with one or more of the first through fourth aspects, a switching time between a downlink reference timing and a CLI measurement timing to measure the set of aperiodic CLI resources is based at least in part on the minimum timing.

In a sixth aspect, alone or in combination with one or more of the first through fifth aspects, the CLI measurement timing is based at least in part on a constant offset relative that is applied to the downlink reference timing in a serving cell, and the constant offset value is based at least in part on a UE implementation and is at least a constant value multiplied by a timing advance offset.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node. Example process 1400 is an example where the apparatus or the network node (e.g., network node 110) performs operations associated with slot offsets for CLI measurement reporting.

As shown in FIG. 14, in some aspects, process 1400 may include transmitting signaling that triggers a set of CLI resources, wherein the set of CLI resources includes CLI SRS-RSRP resources or CLI-RSSI resources (block 1410). For example, the network node (e.g., using transmission component 1604 or communication manager 1606, depicted in FIG. 16) may transmit signaling that triggers a set of CLI resources, wherein the set of CLI resources includes CLI SRS-RSRP resources or CLI-RSSI resources, as described above in connection with reference number 1002 in FIG. 10.

As further shown in FIG. 14, in some aspects, process 1400 may include receiving a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols (block 1420). For example, the network node (e.g., using reception component 1602 or communication manager 1606, depicted in FIG. 16) may receive a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols, as described above in connection with reference number 1004 in FIG. 10.

Process 1400 may include additional aspects, such as any single aspect or any combination of aspects described below or in connection with one or more other processes described elsewhere herein.

In a first aspect, the configuration type is a first configuration type that restricts the CLI SRS-RSRP measurement or the CLI-RSSI measurement to the SBFD symbols or the non-SBFD symbols, or the configuration type is a second configuration type that allows the CLI SRS-RSRP measurement or the CLI-RSSI measurement to be in the SBFD symbols and the non-SBFD symbols.

In a second aspect, alone or in combination with the first aspect, the CLI SRS-RSRP measurement or the CLI-RSSI measurement applies to the SBFD symbols.

In a third aspect, alone or in combination with one or more of the first and second aspects, the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and the CLI SRS-RSRP measurement or the CLI-RSSI measurement are restricted to the SBFD symbols.

In a fourth aspect, alone or in combination with one or more of the first through third aspects, a valid symbol type associated with the CLI SRS-RSRP measurement or the CLI-RSSI measurement is an SBFD symbol type.

In a fifth aspect, alone or in combination with one or more of the first through fourth aspects, the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and the CLI SRS-RSRP measurement or the CLI-RSSI measurement are restricted to the SBFD symbols or the non-SBFD symbols.

In a sixth aspect, alone or in combination with one or more of the first through fifth aspects, the CLI SRS-RSRP measurement or the CLI-RSSI measurement applies to the SBFD symbols or the non-SBFD symbols.

In a seventh aspect, alone or in combination with one or more of the first through sixth aspects, process 1400 includes transmitting, via RRC signaling, an indication of a valid symbol type associated with a CLI measurement, wherein the valid symbol type is defined in a CLI SRS-RSRP measurement resource set or a CLI-RSSI measurement resource set.

In an eighth aspect, alone or in combination with one or more of the first through seventh aspects, process 1400 includes transmitting, via RRC signaling, a CLI report configuration that indicates a valid symbol type associated with a CLI measurement.

In a ninth aspect, alone or in combination with one or more of the first through eighth aspects, a valid symbol type associated with a CLI measurement is based at least in part on a first CLI SRS-RSRP measurement occasion or a first CLI-RSSI measurement occasion.

In a tenth aspect, alone or in combination with one or more of the first through ninth aspects, the first CLI SRS-RSRP measurement occasion or the first CLI-RSSI measurement occasion is after a slot offset for an aperiodic triggered CLI resource.

In an eleventh aspect, alone or in combination with one or more of the first through tenth aspects, the first CLI SRS-RSRP measurement occasion or the first CLI-RSSI measurement occasion is after a MAC-CE activation for a semi-persistent CLI resource.

In a twelfth aspect, alone or in combination with one or more of the first through eleventh aspects, the CLI SRS-RSRP measurement or the CLI-RSSI measurement applies to a configuration type that allows the CLI SRS-RSRP measurement or the CLI-RSSI measurement to be in the SBFD symbols and the non-SBFD symbols, and the CLI SRS-RSRP measurement or the CLI-RSSI measurement are in the SBFD symbols and the non-SBFD symbols.

In a thirteenth aspect, alone or in combination with one or more of the first through twelfth aspects, CLI SRS-RSRP measurements or CLI-RSSI measurements are not averaged between the SBFD symbols and the non-SBFD symbols.

In a fourteenth aspect, alone or in combination with one or more of the first through thirteenth aspects, the set of CLI resources includes wideband CLI SRS-RSRP resources or the CLI-RSSI resources, and a downlink subband CLI measurement or an uplink subband CLI measurement is applied in one or more SBFD symbols based on a predefined rule.

In a fifteenth aspect, alone or in combination with one or more of the first through fourteenth aspects, the report is a CLI SRS-RSRP report or a CLI-RSSI report.

In a sixteenth aspect, alone or in combination with one or more of the first through fifteenth aspects, each SBFD symbol type or non-SBFD symbol type is independently reported via the report, and wherein two report quantities are configured in a report configuration to report CLI separately for each symbol type.

In a seventeenth aspect, alone or in combination with one or more of the first through sixteenth aspects, each SBFD symbol type or non-SBFD symbol type is independently reported via the report, wherein one report quantity is configured in a report configuration, and each report is based at least in part on one symbol type that corresponds to a type of reference resource.

In an eighteenth aspect, alone or in combination with one or more of the first through seventeenth aspects, each SBFD symbol type or non-SBFD symbol type is independently reported via the report, wherein one report quantity is configured in a report configuration, and the report indicates a latest measurement occasion with a corresponding symbol type.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIG. 10. Additionally, or alternatively, the apparatus 1500 may be configured to perform one or more processes described herein, such as process 1100 of FIG. 11, process 1200 of FIG. 12, or a combination thereof. In some aspects, the apparatus 1500 or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The reception component 1502 may receive DCI that triggers a set of aperiodic CLI resources, wherein the set of aperiodic CLI resources includes a set of aperiodic CLI SRS-RSRP resources or a set of aperiodic CLI-RSSI resources. The transmission component 1504 may transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

The reception component 1502 may receive signaling that triggers a set of CLI resources, wherein the set of CLI resources includes CLI SRS-RSRP resources or CLI-RSSI resources. The transmission component 1504 may transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network node, or a network node may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIG. 10. Additionally, or alternatively, the apparatus 1600 may be configured to perform one or more processes described herein, such as process 1300 of FIG. 13, process 1400 of FIG. 14, or a combination thereof. In some aspects, the apparatus 1600 or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 or the transmission component 1604 may include or may be included in a network interface. The network interface may be configured to obtain or output signals for the apparatus 1600 via one or more communications links, such as a backhaul link, a midhaul link, or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

The transmission component 1604 may transmit DCI that triggers a set of aperiodic CLI resources, wherein the set of aperiodic CLI resources includes a set of aperiodic CLI SRS-RSRP resources or a set of aperiodic CLI-RSSI resources. The reception component 1602 may receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

The transmission component 1604 may transmit signaling that triggers a set of CLI resources, wherein the set of CLI resources includes CLI SRS-RSRP resources or CLI-RSSI resources. The reception component 1602 may receive a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes SBFD symbols or non-SBFD symbols.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:
Aspect 1: A method of wireless communication performed by a user equipment (UE), comprising: receiving downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources; and transmitting a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.
Aspect 2: The method of Aspect 1, wherein the slot offset between the slot associated with the DCI that triggers the set of aperiodic CLI SRS-RSRP resources and the slot in which the set of aperiodic CLI SRS-RSRP resources are measured is more than zero slots in accordance with the minimum timing.
Aspect 3: The method of any of Aspects 1-2, wherein the slot offset between the slot associated with the DCI that triggers the set of aperiodic CLI-RSSI resources and the slot in which the set of aperiodic CLI-RSSI resources are measured is not equal to zero slots in accordance with the minimum timing.
Aspect 4: The method of any of Aspects 1-3, wherein the minimum timing is at least one slot to accommodate a timing switching for CLI measurement that occurs at a slot boundary.
Aspect 5: The method of any of Aspects 1-4, further comprising: transmitting an indication of a UE capability of a minimum slot offset supported by the UE, wherein the minimum timing is based at least in part on the indication of the UE capability.
Aspect 6: The method of any of Aspects 1-5, wherein a switching time between a downlink reference timing and a CLI measurement timing to measure the set of aperiodic CLI resources is based at least in part on the minimum timing.
Aspect 7: The method of Aspect 6, wherein the CLI measurement timing is based at least in part on a constant offset relative that is applied to the downlink reference timing in a serving cell, and wherein the constant offset value is based at least in part on a UE implementation and is at least a constant value multiplied by a timing advance offset.
Aspect 8: A method of wireless communication performed by a user equipment (UE), comprising: receiving signaling that triggers a set of cross-link interference (CLI) resources, wherein the set of CLI resources includes CLI sounding reference signal reference signal received power (SRS-RSRP) resources or CLI received signal strength indicator (CLI-RSSI) resources; and transmitting a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes subband full duplex (SBFD) symbols or non-SBFD symbols.
Aspect 9: The method of Aspect 8, wherein: the configuration type is a first configuration type that restricts the CLI SRS-RSRP measurement or the CLI-RSSI measurement to the SBFD symbols or the non-SBFD symbols; or the configuration type is a second configuration type that allows the CLI SRS-RSRP measurement or the CLI-RSSI measurement to be in the SBFD symbols and the non-SBFD symbols.
Aspect 10: The method of any of Aspects 8-9, wherein the CLI SRS-RSRP measurement or the CLI-RSSI measurement applies to the SBFD symbols.
Aspect 11: The method of any of Aspects 8-10, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols.
Aspect 12: The method of any of Aspects 8-11, wherein a valid symbol type associated with the CLI SRS-RSRP measurement or the CLI-RSSI measurement is an SBFD symbol type.
Aspect 13: The method of any of Aspects 8-12, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols or the non-SBFD symbols.
Aspect 14: The method of any of Aspects 8-13, wherein the CLI SRS-RSRP measurement or the CLI-RSSI measurement applies to the SBFD symbols or the non-SBFD symbols.
Aspect 15: The method of any of Aspects 8-14, further comprising: receiving, via radio resource control (RRC) signaling, an indication of a valid symbol type associated with a CLI measurement, wherein the valid symbol type is defined in a CLI SRS-RSRP measurement resource set or a CLI-RSSI measurement resource set.
Aspect 16: The method of any of Aspects 8-15, further comprising: receiving, via radio resource control (RRC) signaling, a CLI report configuration that indicates a valid symbol type associated with a CLI measurement.
Aspect 17: The method of any of Aspects 8-16, wherein a valid symbol type associated with a CLI measurement is based at least in part on a first CLI SRS-RSRP measurement occasion or a first CLI-RSSI measurement occasion.
Aspect 18: The method of Aspect 17, wherein the first CLI SRS-RSRP measurement occasion or the first CLI-RSSI measurement occasion is after a slot offset for an aperiodic triggered CLI resource.
Aspect 19: The method of Aspect 17, wherein the first CLI SRS-RSRP measurement occasion or the first CLI-RSSI measurement occasion is after a medium access control control element (MAC-CE) activation for a semi-persistent CLI resource.
Aspect 20: The method of any of Aspects 8-19, wherein the CLI SRS-RSRP measurement or the CLI-RSSI measurement applies to a configuration type that allows the CLI SRS-RSRP measurement or the CLI-RSSI measurement to be in the SBFD symbols and the non-SBFD symbols, and wherein the CLI SRS-RSRP measurement or the CLI-RSSI measurement are in the SBFD symbols and the non-SBFD symbols.
Aspect 21: The method of Aspect 20, wherein CLI SRS-RSRP measurements or CLI-RSSI measurements are not averaged between the SBFD symbols and the non-SBFD symbols.
Aspect 22: The method of any of Aspects 8-21, wherein the set of CLI resources includes wideband CLI SRS-RSRP resources or the CLI-RSSI resources, and wherein a downlink subband CLI measurement or an uplink subband CLI measurement is applied in one or more SBFD symbols based on a predefined rule.
Aspect 23: The method of any of Aspects 8-22, wherein the report is a CLI SRS-RSRP report or a CLI-RSSI report.
Aspect 24: The method of Aspect 23, wherein each SBFD symbol type or non-SBFD symbol type is independently reported via the report, and wherein two report quantities are configured in a report configuration to report CLI separately for each symbol type.
Aspect 25: The method of Aspect 23, wherein each SBFD symbol type or non-SBFD symbol type is independently reported via the report, wherein one report quantity is configured in a report configuration, and wherein each report is based at least in part on one symbol type that corresponds to a type of reference resource.
Aspect 26: The method of Aspect 23, wherein each SBFD symbol type or non-SBFD symbol type is independently reported via the report, wherein one report quantity is configured in a report configuration, and wherein the report indicates a latest measurement occasion with a corresponding symbol type.
Aspect 27: A method of wireless communication performed by a network node, comprising: transmitting downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources; and receiving a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.
Aspect 28: The method of Aspect 27, wherein the slot offset between the slot associated with the DCI that triggers the set of aperiodic CLI SRS-RSRP resources and the slot in which the set of aperiodic CLI SRS-RSRP resources are measured is more than zero slots in accordance with the minimum timing.
Aspect 29: The method of any of Aspects 27-28, wherein the slot offset between the slot associated with the DCI that triggers the set of aperiodic CLI-RSSI resources and the slot in which the set of aperiodic CLI-RSSI resources are measured is not equal to zero slots in accordance with the minimum timing.
Aspect 30: The method of any of Aspects 27-29, wherein the minimum timing is at least one slot to accommodate a timing switching for CLI measurement that occurs at a slot boundary.
Aspect 31: The method of any of Aspects 27-30, further comprising: receiving an indication of a UE capability of a minimum slot offset supported by the UE, wherein the minimum timing is based at least in part on the indication of the UE capability.
Aspect 32: The method of any of Aspects 27-31, wherein a switching time between a downlink reference timing and a CLI measurement timing to measure the set of aperiodic CLI resources is based at least in part on the minimum timing.
Aspect 33: The method of Aspect 32, wherein the CLI measurement timing is based at least in part on a constant offset relative that is applied to the downlink reference timing in a serving cell, and wherein the constant offset value is based at least in part on a UE implementation and is at least a constant value multiplied by a timing advance offset.
Aspect 34: A method of wireless communication performed by a network node, comprising: transmitting signaling that triggers a set of cross-link interference (CLI) resources, wherein the set of CLI resources includes CLI sounding reference signal reference signal received power (SRS-RSRP) resources or CLI received signal strength indicator (CLI-RSSI) resources; and receiving a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes subband full duplex (SBFD) symbols or non-SBFD symbols.
Aspect 35: The method of Aspect 34, wherein: the configuration type is a first configuration type that restricts the CLI SRS-RSRP measurement or the CLI-RSSI measurement to the SBFD symbols or the non-SBFD symbols; or the configuration type is a second configuration type that allows the CLI SRS-RSRP measurement or the CLI-RSSI measurement to be in the SBFD symbols and the non-SBFD symbols.
Aspect 36: The method of any of Aspects 34-35, wherein the CLI SRS-RSRP measurement or the CLI-RSSI measurement applies to the SBFD symbols.
Aspect 37: The method of any of Aspects 34-36, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols.
Aspect 38: The method of any of Aspects 34-37, wherein a valid symbol type associated with the CLI SRS-RSRP measurement or the CLI-RSSI measurement is an SBFD symbol type.
Aspect 39: The method of any of Aspects 34-38, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols or the non-SBFD symbols.
Aspect 40: The method of any of Aspects 34-39, wherein the CLI SRS-RSRP measurement or the CLI-RSSI measurement applies to the SBFD symbols or the non-SBFD symbols.
Aspect 41: The method of any of Aspects 34-40, further comprising: transmitting, via radio resource control (RRC) signaling, an indication of a valid symbol type associated with a CLI measurement, wherein the valid symbol type is defined in a CLI SRS-RSRP measurement resource set or a CLI-RSSI measurement resource set.
Aspect 42: The method of any of Aspects 34-41, further comprising: transmitting, via radio resource control (RRC) signaling, a CLI report configuration that indicates a valid symbol type associated with a CLI measurement.
Aspect 43: The method of any of Aspects 34-42, wherein a valid symbol type associated with a CLI measurement is based at least in part on a first CLI SRS-RSRP measurement occasion or a first CLI-RSSI measurement occasion.
Aspect 44: The method of Aspect 43, wherein the first CLI SRS-RSRP measurement occasion or the first CLI-RSSI measurement occasion is after a slot offset for an aperiodic triggered CLI resource.
Aspect 45: The method of Aspect 43, wherein the first CLI SRS-RSRP measurement occasion or the first CLI-RSSI measurement occasion is after a medium access control control element (MAC-CE) activation for a semi-persistent CLI resource.
Aspect 46: The method of any of Aspects 34-45, wherein the CLI SRS-RSRP measurement or the CLI-RSSI measurement applies to a configuration type that allows the CLI SRS-RSRP measurement or the CLI-RSSI measurement to be in the SBFD symbols and the non-SBFD symbols, and wherein the CLI SRS-RSRP measurement or the CLI-RSSI measurement are in the SBFD symbols and the non-SBFD symbols.
Aspect 47: The method of Aspect 46, wherein CLI SRS-RSRP measurements or CLI-RSSI measurements are not averaged between the SBFD symbols and the non-SBFD symbols.
Aspect 48: The method of any of Aspects 34-47, wherein the set of CLI resources includes wideband CLI SRS-RSRP resources or the CLI-RSSI resources, and wherein a downlink subband CLI measurement or an uplink subband CLI measurement is applied in one or more SBFD symbols based on a predefined rule.
Aspect 49: The method of any of Aspects 34-48, wherein the report is a CLI SRS-RSRP report or a CLI-RSSI report.
Aspect 50: The method of Aspect 49, wherein each SBFD symbol type or non-SBFD symbol type is independently reported via the report, and wherein two report quantities are configured in a report configuration to report CLI separately for each symbol type.

Aspect 51: The method of Aspect 49, wherein each SBFD symbol type or non-SBFD symbol type is independently reported via the report, wherein one report quantity is configured in a report configuration, and wherein each report is based at least in part on one symbol type that corresponds to a type of reference resource.

Aspect 52: The method of Aspect 49, wherein each SBFD symbol type or non-SBFD symbol type is independently reported via the report, wherein one report quantity is configured in a report configuration, and wherein the report indicates a latest measurement occasion with a corresponding symbol type.
Aspect 53: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-52.
Aspect 54: An apparatus for wireless communication at a device, the apparatus comprising one or more memories and one or more processors coupled to the one or more memories, the one or more processors configured to cause the device to perform the method of one or more of Aspects 1-52.
Aspect 55: An apparatus for wireless communication, the apparatus comprising at least one means for performing the method of one or more of Aspects 1-52.
Aspect 56: A non-transitory computer-readable medium storing code for wireless communication, the code comprising instructions executable by one or more processors to perform the method of one or more of Aspects 1-52.
Aspect 57: A non-transitory computer-readable medium storing a set of instructions for wireless communication, the set of instructions comprising one or more instructions that, when executed by one or more processors of a device, cause the device to perform the method of one or more of Aspects 1-52.
Aspect 58: A device for wireless communication, the device comprising a processing system that includes one or more processors and one or more memories coupled with the one or more processors, the processing system configured to cause the device to perform the method of one or more of Aspects 1-52.
Aspect 59: An apparatus for wireless communication at a device, the apparatus comprising one or more memories and one or more processors coupled to the one or more memories, the one or more processors individually or collectively configured to cause the device to perform the method of one or more of Aspects 1-52.
Aspect 60: A device comprising a processing system that includes one or more processors and one or more code-storing memories coupled with the one or more processors, the processing system configured to cause the device to perform the method of one or more of Aspects 1-52.
Aspect 61: A device comprising a processing system that includes processor circuitry and code-storing memory circuitry, the processing system configured to cause the device to perform the method of one or more of Aspects 1-52.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources; and
transmit a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.

2. The apparatus of claim 1, wherein the slot offset between the slot associated with the DCI that triggers the set of aperiodic CLI SRS-RSRP resources and the slot in which the set of aperiodic CLI SRS-RSRP resources are measured is more than zero slots in accordance with the minimum timing.

3. The apparatus of claim 1, wherein the slot offset between the slot associated with the DCI that triggers the set of aperiodic CLI-RSSI resources and the slot in which the set of aperiodic CLI-RSSI resources are measured is not equal to zero slots in accordance with the minimum timing.

4. The apparatus of claim 1, wherein the minimum timing is at least one slot to accommodate a timing switching for CLI measurement that occurs at a slot boundary.

5. The apparatus of claim 1, wherein the one or more processors are further configured to cause the UE to:
transmit an indication of a UE capability of a minimum slot offset supported by the UE, wherein the minimum timing is based at least in part on the indication of the UE capability.

6. The apparatus of claim 1, wherein a switching time between a downlink reference timing and a CLI measurement timing to measure the set of aperiodic CLI resources is based at least in part on the minimum timing.

7. The apparatus of claim 6, wherein the CLI measurement timing is based at least in part on a constant offset relative that is applied to the downlink reference timing in a serving cell, and wherein the constant offset value is based at least in part on a UE implementation and is at least a constant value multiplied by a timing advance offset.

8. An apparatus for wireless communication at a user equipment (UE), comprising:
one or more memories; and
one or more processors, coupled to the one or more memories, configured to cause the UE to:
receive signaling that triggers a set of cross-link interference (CLI) resources, wherein the set of CLI resources includes CLI sounding reference signal reference signal received power (SRS-RSRP) resources or CLI received signal strength indicator (CLI-RSSI) resources; and
transmit a report of one or more measurements associated with the set of CLI resources, wherein the one or more measurements includes one or more of a CLI SRS-RSRP measurement or a CLI-RSSI measurement, wherein the one or more measurements apply to one or more of a configuration type or a symbol type, and wherein the symbol type includes subband full duplex (SBFD) symbols or non-SBFD symbols.

9. The apparatus of claim 8, wherein:
the configuration type is a first configuration type that restricts the CLI SRS-RSRP measurement or the CLI-RSSI measurement to the SBFD symbols or the non-SBFD symbols; or
the configuration type is a second configuration type that allows the CLI SRS-RSRP measurement or the CLI-RSSI measurement to be in the SBFD symbols and the non-SBFD symbols.

10. The apparatus of claim 8, wherein the CLI SRS-RSRP measurement or the CLI-RSSI measurement applies to the SBFD symbols.

11. The apparatus of claim 8, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols.

12. The apparatus of claim 8, wherein a valid symbol type associated with the CLI SRS-RSRP measurement or the CLI-RSSI measurement is an SBFD symbol type.

13. The apparatus of claim 8, wherein the CLI SRS-RSRP measurement or the CLI-RSSI measurement applies to a configuration type that restricts the CLI SRS-RSRP measurement or the CLI-RSSI measurement to the SBFD symbols or the non-SBFD symbols, and wherein the CLI SRS-RSRP measurement or the CLI-RSSI measurement are restricted to the SBFD symbols or the non-SBFD symbols.

14. The apparatus of claim 8, wherein the CLI SRS-RSRP measurement or the CLI-RSSI measurement applies to the SBFD symbols or the non-SBFD symbols.

15. The apparatus of claim 8, wherein the one or more processors are further configured to cause the UE to:
receive, via radio resource control (RRC) signaling, an indication of a valid symbol type associated with a CLI measurement, wherein the valid symbol type is defined in a CLI SRS-RSRP measurement resource set or a CLI-RSSI measurement resource set.

16. The apparatus of claim 8, wherein the one or more processors are further configured to cause the UE to:
receive, via radio resource control (RRC) signaling, a CLI report configuration that indicates a valid symbol type associated with a CLI measurement.

17. The apparatus of claim 8, wherein a valid symbol type associated with a CLI measurement is based at least in part on a first CLI SRS-RSRP measurement occasion or a first CLI-RSSI measurement occasion.

18. The apparatus of claim 17, wherein the first CLI SRS-RSRP measurement occasion or the first CLI-RSSI measurement occasion is after a slot offset for an aperiodic triggered CLI resource.

19. The apparatus of claim 17, wherein the first CLI SRS-RSRP measurement occasion or the first CLI-RSSI measurement occasion is after a medium access control control element (MAC-CE) activation for a semi-persistent CLI resource.

20. A apparatus for wireless communication performed at a network node, comprising:
one or more memories; and
one or more processors, coupled to the one or more memories, configured to cause the network node to:
transmit downlink control information (DCI) that triggers a set of aperiodic cross-link interference (CLI) resources, wherein the set of aperiodic CLI resources includes a set of aperiodic CLI sounding reference signal reference signal received power (SRS-RSRP) resources or a set of aperiodic CLI received signal strength indicator (CLI-RSSI) resources; and
receive a report of one or more measurements associated with the set of aperiodic CLI resources, wherein a slot offset between a slot associated with the DCI that triggers the set of aperiodic CLI resources and a slot in which the set of aperiodic CLI resources are measured is based at least in part on a minimum timing.
